(19) United States
(12) Patent Application Publication
(10) Pub. No.: US 2013/0052105 A1
(43) Pub. Date: Feb. 28, 2013

(54) System and Method for Processing Aqueous Solutions

(71) Applicant: James Charles Butler, Cherry Hill, NJ (US)

(72) Inventor: James Charles Butler, Cherry Hill, NJ (US)

(73) Assignee: B9 Plasma, Inc., Mount Laurel, NJ (US)

(21) Appl. No.: 13/595,946

(22) Filed: Aug. 27, 2012

Related U.S. Application Data
(60) Provisional application No. 61/527,456, filed on Aug. 25, 2011.

(51) Int. Cl. C22B 7/00; C01G 49/06; B01D 21/01; C01G 49/02; B01D 19/00; B01D 21/26

(52) U.S. Cl. 423/140; 422/187; 423/1

(57) ABSTRACT

A system and method for processing aqueous solutions is provided. A method for controlled bubble collapse is provided, which catalyzes chemical reactions in aqueous solutions that cause metal and other ions and compounds in solution to form hydroxide, oxide, protonated, polyatomic and other stable precipitate species, compounds or complexes. The reactions convert metal ions in solution into stable metal hydroxide, oxide and other precipitates or solid complexes. Further processing including recirculation, detention, precipitate formation and detection can be utilized. Pressure and flow modulated and regulated recirculation of precipitate laden aqueous solution through a hydrocyclone particle or precipitate separation circuit can also be utilized.

### CROSS-REFERENCE TO RELATED APPLICATION

This application claims the priority of U.S. Provisional Application Ser. No. 61/527,456 filed Aug. 25, 2011, the entire disclosure of which is expressly incorporated herein by reference.

### FIELD OF THE INVENTION

The present invention relates generally to a system and method for processing aqueous solutions, and more specifically, to a system and method for processing aqueous solutions using controlled aqueous solution bubble formation and collapse, resulting in formation of oxide and hydroxide precipitates and alkane gas products.

### BACKGROUND OF THE INVENTION

Processing aqueous solutions to remove precipitates has, in the past, involved the use of lime, soda ash, alum, polymer-based, or other types of coagulants or flocculants, or chemical additive pH changes that result in the formation of sweep flocculent as a mechanism to reduce the TDS of aqueous solutions. The chemical additive methods can be effective for water content remediation, but offer no mechanism to recover the dissolved solids as separate compositions. Metal mining influenced waters are commonly produced as a consequence of the mining of gold, silver, copper, coal, clay, bitumen, sulfur, other metals and minerals. During and after ore extraction from the environment, subsequent processing to isolate, separate and recover target materials from raw ore feedstock using hydrometallurgical or other aqueous process or metal extraction circuits results in the release of metals and metal sulfides, where present, into the environment. Engineering controls are commonly implemented to ameliorate this effect, but the existence of large AMD Superfund sites (Berkeley Pit) indicates that these methods of control are not entirely effective. In coal and clay mining, sulfur present in the ore results in acidification of surface waters and consequent dissolution of metals from underlying rock over time.

Conventional treatments of AMD and mining influenced water focus on water remediation, primarily through pH adjustment and forced sweep flocculation of metal contaminants in solution. This approach does not contemplate metal recovery or metal species isolation, and requires the addition or chemical agents, acids, bases, salts, polymers or other flocculants. The solids produced through forced sweep flocculation consist of deliquescent metal salts and oxyhydroxides and consist of amalgamated, comingled metal, including any present in the mining influenced water. This could include arsenic, cadmium, chromium, copper, lead, nickel, selenium, vanadium, or zinc, any of which will co-precipitate with iron using chemical flocculation. The resulting slurry is of little value, does not consist of readily recoverable compositions, and may required expensive handling and disposal techniques.

### SUMMARY OF THE INVENTION

The present invention relates to a system and method for processing aqueous solutions. A method for controlled bubble collapse is provided, which catalyzes chemical reactions in aqueous solutions that cause metal and other ions and compounds in solution to form hydroxide, oxide, protonated, polyatomic and other stable precipitate species, compounds or complexes. When the bubbles collapse in an aqueous solution, water splitting and other reactions are catalyzed by the effects of the high pressure and temperature in the domain of bubble collapse. The reactions convert metal ions in solution into stable metal hydroxide, oxide and other precipitates or solid complexes. Where carbonaceous compounds are present in suspension or solution, these compounds are hydrolyzed or protonated as a result of the water splitting and dissolved metal and other ion hydroxide scavenging, yielding methane, propane, and other alkane gases and liquids. Further processing including recirculation, detention, precipitate formation and detection can be utilized. Pressure and flow modulated and regulated recirculation of precipitate laden aqueous solution through a hydrocyclone particle or precipitate separation circuit can also be utilized.

### BRIEF DESCRIPTION OF THE DRAWINGS

FIG. 1 shows the interconnection between FIGS. 1A and 1B.

FIGS. 1A-1B show piping and instrumentation diagrams, split over two pages, depicting an example of an implementation of the apparatus of the present invention showing the pump system, subsystems, components and controller used to start, sustain and control bubble collapse catalyzed conversion of dissolved solids to separable precipitates and fuel gas.

FIG. 2 shows the interconnection between FIGS. 2A and 2B.

FIGS. 2A-2B show piping and instrumentation diagrams, split over two pages, depicting an example implementation of the present invention for detention, precipitate formation, detection and separation.

FIG. 3 is a process schematic diagram showing an example of a portable implementation of the present invention for use in the field in conjunction with conventional wastewater handling and treatment equipment for production scale hydraulic fracturing flowback, acid mine drainage or industrial process wastewater total dissolved solids (“TDS”) reduction, solids recovery and recycling.

FIGS. 4-15 are graphs illustrating various performance characteristics in connection with tests performed using the system.

### DETAILED DESCRIPTION OF THE INVENTION

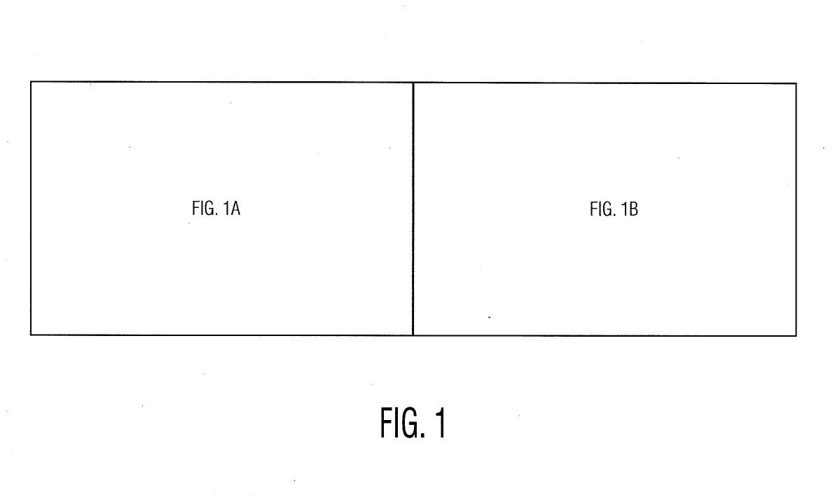

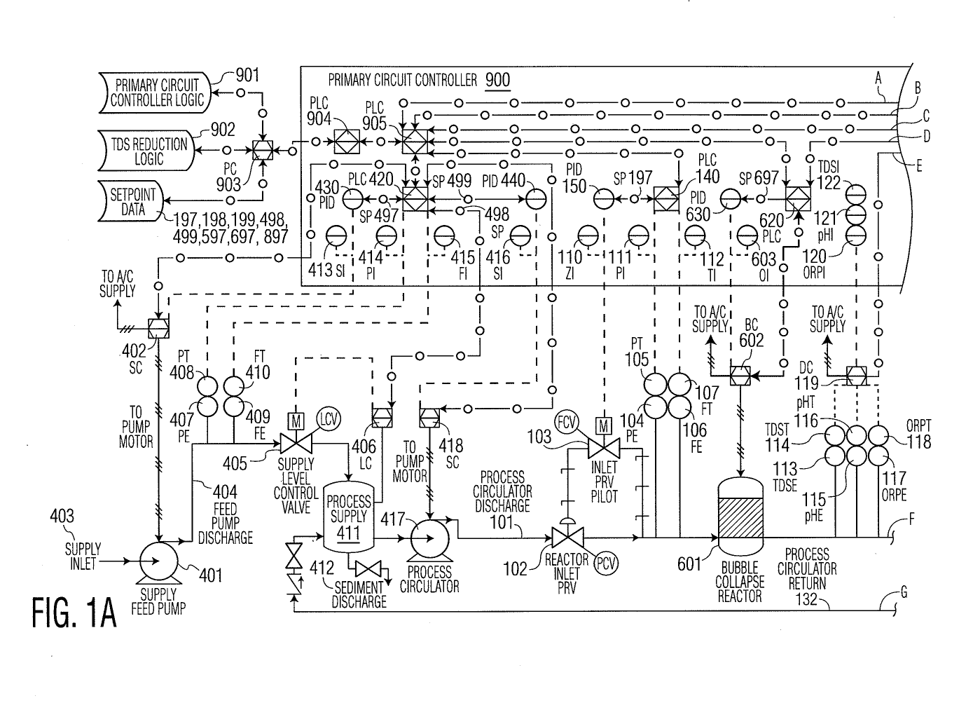

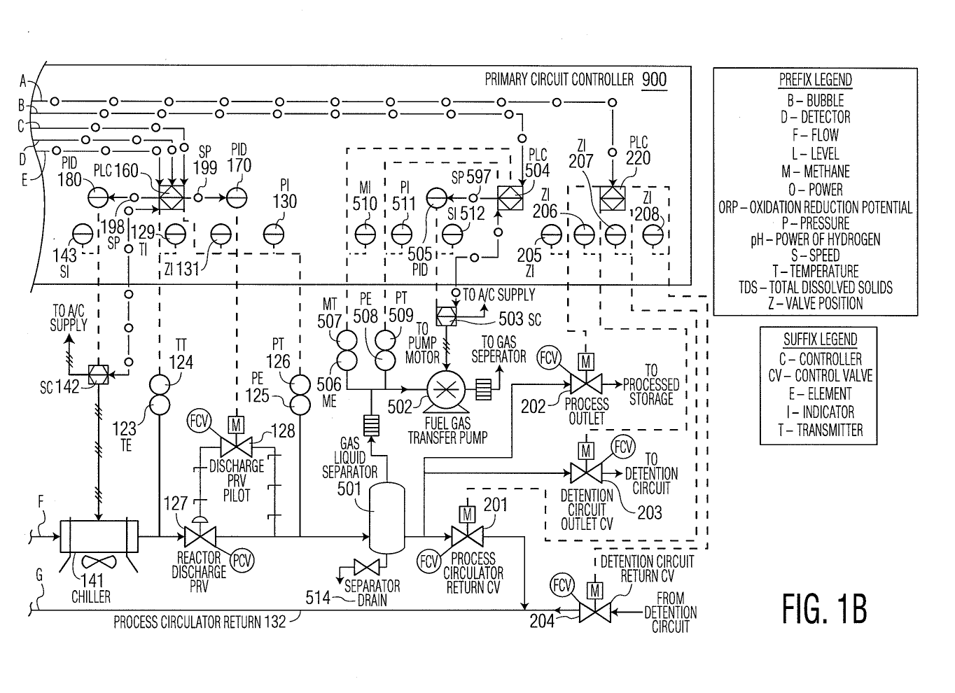

The present invention relates to a system and method for processing aqueous solutions, as discussed in detail below in connection with FIGS. 1-15. Controlled bubble collapse is used to catalyze chemical reactions in aqueous solutions that cause metal and other ions and compounds in solution to form hydroxide, oxide, protonated, polyatomic and other stable precipitate species, compounds or complexes. When the bubbles collapse in an aqueous solution, water splitting and other reactions are catalyzed by the effects of the high pressure and temperature in the domain of bubble collapse. The reactions convert metal ions in solution into stable metal hydroxide, oxide and other precipitates or solid complexes. Where carbonaceous compounds are present in suspension or solution, these compounds are hydrolyzed or protonated as a consequence of the water splitting and dissolved metal and other ion hydroxide scavenging, yielding methane, propane, and other alkane gases and liquids.

The properties of a collapsing gas and water vapor containing bubbles in water are used as a catalyst for reactions between the water vapor or aqueous media and minerals or compounds dissolved in the aqueous media or present as suspended particulates or solids in the aqueous media, or as a catalyst for reactions between the solids in an aqueous solution or suspension and the aqueous media, or water, vapor, oxygen, hydrogen or other gases contained in the bubble, or dissolved in the aqueous media.

A system and method is provided to adapt to and control a bubble collapse reactor provided with or without intrinsic advanced process controls. The systems and methods are designed for compatibility with the reactor subsystem as depicted herein or another type of bubble collapse or cavitational reactor based on any method of forming and collapsing bubbles under supervisory control, including methods implementing ultrasonics, lasers, hydrodynamic vortices or fittings, hydrodynamic pumping or pressure manipulation, or some combination or hybrid method. Each of the various aforementioned cavitational or bubble collapse systems and methods has a different set of parameters for effective control and are partially or fully automated in a particular physical implementation of the cavitational or bubble collapse system and method. To accommodate this variety in potential cavitational or bubble collapse reactors, systems, methods or implementations, interconnected, interoperable, componentized, subsystems are provided wherein the primary operating parameter values are sourced from the subsystems themselves, a central controller or, if so capable, the bubble collapse reactor itself. In this way, a reactor outfitted for self-regulation and self-optimization can provide functions and operating conditions to support this self-regulation. Where a bubble collapse or cavitational reactor has no intrinsic regulation capacity, the apparatus subsystems or central controller can provide the operational parameter value regulation required to optimize the reactor's performance.

A precipitation circuit apparatus and control system is provided for recycling of all reagents, reactants, solids, liquids and gases added to or evolved during system operation. Several closed loop processing circuit options and batch processing options for precipitate and gas product formation are entirely sealed, such that no solid, liquid or gas is emitted during bubble collapse reaction catalysis or processing. The system may include components to monitor and separate gases, liquids and solids during and after processing using methods that permit controlled redirection of the effluent substances, including methods to control dissolved and headspace gases, liquid fractions and solid fractions. The apparatus can also degrade water contaminants and react and degrade solid, liquid and gases from the feedstock water processing. In this way, the apparatus can operate in a zero emission mode and can retain and recycle feedstock and product solids, liquids and gases.

Apparatus and methods are provided to correlate the cavitational or bubble collapse subsystem chemical catalysis, precipitate and gas production performance, power usage, subsystem operational pressure, flow, temperature, pH, oxidation reduction potential (“ORP”), dissolved oxygen (“DO”), total dissolved solids (“TDS”), total suspended solids (“TSS”) and others as these parameter values require modification during operation. As the aqueous solution is subjected to processing, chemical and physical changes, such as oxidation or reduction of compounds in solution, dissolution of suspended solids, precipitation of dissolved solids, production and dissolution of product gases or precipitate floculant formation, cause changes in the performance such that initial operational parameter value ranges, process variable selections and setpoints may no longer provide optimal performance. The apparatus contains sensors and components and the control logic includes algorithms to identify and to select for control those process variables whose control and ranges provide optimal apparatus productivity. In addition, the apparatus control system algorithms provide logic to both change operational setpoints and to drive control of the system based on any of the measured process variables, based on the degree to which control of a selected process variable provides predictable process control. In addition, these algorithms permit a selected controlling process variable's range to have a variable statistical weighting when used in combination with other process variables or when compared to other process variables. In this way, chemical reactivity, precipitate and alkane gas production performance as a function of power consumed are controlled by that process variable or variables across a selected range and with setpoints so that control and performance are optimized and maximized.

A computer-controlled bubble collapse reactor is comprised of several independent subsystems that together provide the functionality for controlled bubble collapse catalyzed reactions in aqueous solutions. The apparatus and process are suited for use with various industrial waste stream feedstock, including hydrofrack flowback water, acid mine drainage water, paper pulp processing effluent or other aqueous feedstock waters with dissolved solids (for example, with >220 ppm total dissolved solids) where some or all of the dissolved solids are to be removed or recovered.

Reactions catalyzed result in the formation of recoverable stable precipitate and fuel gas process products. These reactions include water splitting, hydrolysis, protonation, oxidation, reduction, redox and others as catalyzed through acid/base chemistry and as a consequence of bubble collapse generated hydronium and hydroxide. These catalytic mechanisms enable closed aqueous process circuit conversion of carbonaceous compounds in solution and suspension to alkane fuel gases and conversion of minerals, metallic ions and salts in solution to stable, recoverable precipitates. Conversion of dissolved solids to fuel gas and stable precipitates and subsequent recovery and extraction of the process product precipitate and gas results in the reduction of total dissolved solids in the process solution.

Subsystems and components are provided for external measurement and control of bubble properties and collapse mechanisms and the reactions catalyzed. Process state detection and control parameters include feedstock solids density and flow rate, aqueous solution total dissolved solids, total suspended solids, dissolved oxygen, oxidation reduction potential, pH, aqueous circuit and process reactor delivery pressures, temperatures, power consumption, sub-system step down pressures, and circuit, reactor, and product gas pressures and gas concentrations. These parameter values may be monitored and controlled by the bubble collapse reactor, or by the controller, so that operation of dependent or independent subsystems effectively enable reaction catalysis and process throughput rate optimization.

Operational configurations can be modified to enable continuous recirculation, inline or batch processing. Different configurations can provide aqueous solution or suspension processing steps, including slurry or solids mixing, fluids and solids separation, degassing, gas testing, dissolved and suspended solids concentration testing and control, pH and ORP testing and control, gas concentration testing and control, total power measurement and control, bubble collapse reactor power measurement and control, as well as apparatus for full recovery of solids, liquids and gases added to or that evolve during aqueous solution processing.

Aqueous solution detention and particle isolation circuits are provided for post bubble collapse reaction process steps for particle or precipitate separation and concentration and particle or precipitate sorting by size.

The apparatus has at least three separate operational configurations, at least one for each of the following tasks:

Bubble Collapse Catalyzed Conversion of Dissolved and Suspended Solids—Pressure, flow, temperature and bubble collapse energy controlled aqueous solution, bubble collapse catalyzed conversion of dissolved solids to stable precipitates and gases with inline gas and precipitate harvesting, resulting in reduction in total dissolved solids in the processed aqueous solution.

Processed Aqueous Solution Detention, Precipitate Formation and Detection—Controlled recirculation, transfilling and storage tank detention of processed aqueous solution with detection of pH, total dissolved solids and total suspended solids.

Processed Aqueous Solution Precipitate Separation—Pressure and flow modulated and regulated recirculation of precipitate laden aqueous solution through a hydrocyclone particle or precipitate separation circuit.

The aforementioned alternate operation configurations are provided to allow conversion of dissolved solids in feedstock waste and process waters to recover fuel gases and precipitates using a variety of process conditions as controlled by one of several possible process variables. Both automatic and manual selection and control of process variable values can be provided in each of the configurations.

The physical configuration of the apparatus can be changed or modified from one of the aforementioned configurations to another or to any possible hybrid configuration state before, during or after operation. This enables the support of reactions, separations and other types of processing requiring variable process steps or sequencing, including alternate methods or alternate configurations not contemplated herein, and operation optimizations, as required for apparatus application development and adaptations to feedstock variances, are possible during system operation.

Referring to FIGS. 1A-1B, and hereinafter proceeding downstream following the direction of flow, hydrofrack flowback, acid mine drainage, industrial process effluent, ground water or another aqueous solution is pumped by the Supply Feed Pump 401 from a holding tank, pit, pond, truck or other vessel (not shown) through the Supply Inlet 403, out the Feed Pump Discharge 404, through the Supply Level Control Valve 405 and into the Process Supply vessel or tank 411. The Level Controller (LC) 406 measures the Process Supply level in the Process Supply vessel 411 using float, ultrasonic or other liquid level detection devices, and regulates supply inflow by modulating the position of the Supply Level Control Valve 405. The Level Controller 406 can also send low or high level signals through Programmable Logic Controller (“PLC”) 420 to Speed Controller 402 to direct the Supply Feed Pump 401 to increase or decrease speed, start or stop, as required to achieve or maintain a preset or setpoint level of delivered Process Supply in the Process Supply vessel 411 in accordance with a minimum or a maximum or a range. It is noted that the Process Supply vessel 411 could include a sediment discharge valve 412 for discharging sediment from the vessel 411.

The pump system incorporates a controller that provides a speed setpoint signal to the pump motor drive, and pressure and flow setpoint signals used as process variables to calculate the required adjustments to an actual pump speed setpoint. Once the level in the Process Supply 411 has reached the process start minimum level setpoint (“SP”) 498, the Process Circulator pump 417 starts and runs at its speed setpoint (SP) 499, controlled by Speed Controller 418, pumping process solution from the Process Supply vessel 411 through the Process Circulator 417 and out the Process Circulator Discharge 101.

The pump control system can dynamically calculate optimal pump speed and pump system pressure and flow as required to effectively maintain fixed total power consumption as distributed between a bubble collapse reactor and its supporting apparatus, and as required to start and sustain the formation in the pumped media of a specific number of gas and/or vapor bubbles of a particular size and then subsequently collapse the same bubbles at a particular rate to a specific ultimate final bubble size.

Process solution continues downstream through and out the Reactor Inlet Pressure Regulating Valve (“PRV”) 102, which controls and regulates downstream pressure and flow, including pressure and flow within the Bubble Collapse Reactor 601. The Bubble Collapse Reactor 601 generates bubbles in the process solution. Any suitable bubble production method using suitable apparatus and methods can be employed. It is expected that a useful configuration of the Bubble Collapse Reactor 601 will produce a steady, linear bubble stream in the range of approximately 9,000 to 10,000 bubbles per second, for example, with stable bubble diameters in the range of approximately 0.5 microns to 1 mm, for example. The aforementioned ranges can vary for different operating conditions. Also, it is desirable for the Bubble Collapse Reactor 601 to produce a linear stream of bubbles as opposed to uncontrolled clouds of bubbles produced by some types of bubblers and elements of cavitation reactors, even if the number and size of bubbles in the cloud are controlled. Other bubble generator apparatus that may be used include, but are not limited to, apparatus disclosed in commonly-owned, co-pending U.S. patent application Ser. Nos. 13/076,360; 13/240,836; and 13/240,990, the entire disclosures of which are expressly incorporated herein by reference. For example, gas bubbles could be aspirated through an educator comprising a venturi having a side port for gas admittance. Pressure control before and after the venturi allows for the production of bubbles at a controlled rate. Alternatively, a venturi could be used to generate bubbles.

Reactor Inlet PRV 102 position is controlled by a motorized pilot valve, Inlet PRV Pilot 103, according to the downstream flow and pressure set point (“SP”) 197. Process solution pressure and flow rate through the Bubble Collapse Reactor 601 are measured by pressure and flow detectors/transmitters PE 104/PT 105 and FE 106/FT 107, which are installed immediately downstream of the Reactor Inlet PRV 102 and immediately upstream of the Bubble Collapse Reactor 601. By manipulating the speed of the Process Circulator 417 in conjunction with the Reactor Inlet PRV 102 position, it is possible to deliver to the Bubble Collapse Reactor 601 process solution across a wide range of flows and pressures, the maximum ranges controlled by the size and capacities of the pumps and valves employed.

Process solution continues downstream into, through and out of the Bubble Collapse Reactor 601. During operation, once flow and pressure are stabilized at the set points 197, 498, the reactor is activated and operates at an amplitude, pressure, power, speed or other parameter specification as included in the control set points array 697 for Bubble Collapse Reactor 601.

Continuing downstream, the process solution passes through the detector manifolds or array. The detectors may be clean in place (“CIP”), tee or flowcell mounted, or other immersible, pressure tolerant or inline process rated types, and may consist of discrete or integrated detector/transmitter elements or components. The detectors/element combinations can include those for Total Dissolved Solids, i.e., TDSE 113 and TDST 114; detectors/element combinations for pH, i.e., pHE 115 and pHT 116; oxidation reduction potential, i.e., ORPE 117 and ORPT 118; temperature, i.e., TE 123 and TT 124, dissolved oxygen, CO2, methane, or other soluble gas (not shown), or other solute or solvent compositional or elemental detector, as may be useful or necessary to properly characterize a processing effect on a particular feedstock solution.

The process solution flows out of the detector array and through the Chiller 141, which can be a combination chiller/heat exchanger with integral cooling system, or the process solution could flow through a tube or plate heat exchanger with an external pumping system and refrigeration unit. The process circuit cooling apparatus could be sized such that the largest cooling or heating load expected during normal operation can be accommodated and so that set point temperatures or ranges can be achieved and maintained during continuous invention operation. Optimal processing temperature or temperature range setpoints 198 for precipitate formation vary, but process solution temperatures between 20° C. and 30° C. represent likely useful ranges. Temperature sensors can be installed in the same manifold or array as other detectors, or, to increase accuracy in process water temperature control, the temperature sensing element should be downstream of both the reactor and chiller—in this way the total combined temperature effect on the process solution heating caused by the reactor and the cooling caused by the chiller can be measured together.

Following reactor processing and cooling, process solution is now ready for product gas degassing and removal. To achieve these, the process solution next passes through the Reactor Discharge PRV 127, the position of which is controlled by its motorized pilot valve, Discharge PRV Pilot 128, according to the downstream flow and pressure set point (SP 199), and as measured by the downstream pressure detectors/transmitters PE 125 and PT 126. The line pressure in the zone of control downstream of the Reactor Discharge PRV 127 will be reduced to the level that permits optimal separation of the expected dissolved product gases—a step down of approximately 2 to 50 psi is likely useful range to permit production level gas separation in downstream apparatus.

Next, process solution flows into the Gas Liquid Separator 501, at the step down pressure and flow delivered as regulated by the Reactor Discharge PRV 127 according to the reactor downstream pressure set point (SP 199). Process solution passes out of the separator, process product and dissolved gases are harvested through vacuum off-gassing within the Gas Liquid Separator 501. The Fuel Gas Transfer Pump 502 maintains a setpoint headspace vacuum (SP 597) in Gas Liquid Separator 501, drawing away atmospheric and product gases contained in the separator headspace and dissolved in the process solution. The operational speed of the Fuel Gas Transfer Pump 502 and consequent vacuum are regulated and measured by pressure detector/transmitter PE 508 and PT 509 so as to maximize fuel gas extraction rate, as measured by methane gas concentration detector/transmitter ME 506 and MT 507. A likely useful vacuum for methane harvest would be in the range of approximately 1″-5″ Hg for gas extraction from aqueous solutions with low salt content; briny solutions with TDS in excess of 20,000 mS/cm or with Ba, Ca, or other salts in excess of 3% TDS may require approximately 10″-20″ Hg vacuum for effective removal of dissolved CO, CO2 and alkane fuel gases.

At this point, the process solution has completed one process circuit. This may be sufficient processing, based on changes in TDS, TSS or pH as measured by the aforementioned inline process detectors. Alternately, it may be necessary to recirculate the aqueous solution in process in order to reach a target TSS, TDS, pH or some combination target. To facilitate this, and to permit detention and further process step execution and control, aqueous solution discharge from the primary process circuit termination off-gassing step can be redirected to one of three separate targets.

If the current process cycle is complete, then the process solution can be redirected out of the primary circuit and out of the system. This is accomplished by closing Process Circulator Return CV 201 and Detention Circuit Outlet CV 203 and opening Process Outlet 202. When the primary circuit outlet valves are in this position, the contents of Process Supply, such as hydrofrack flowback supply, once processed, are discharged out of the system to an external process (not shown) or a processed solution receiver (not shown).

This discharge configuration also accommodates single pass continuous processing. In a continuous single pass process configuration, the Supply Feed Pump 401 would continuously replenish the Process Supply from an external process solution supply, the Process Circulator 417 would operate as required to sustain the required pressure and flow for continuous bubble collapse processing and process aqueous solution would pass through the primary process circuit and out of the Process Outlet 202.

If a more than a single primary process circuit pass is required, then the Process Outlet valve 202 is closed, Process Circulator Return CV 201 is opened, Detention Circuit Outlet CV 203 is closed, Detention Circuit Return CV 204 is closed, and process solution is redirected to the Process Circulator Return line or pipe 132. In this configuration, the Process Circulator 417 uses the Process Supply as both the process solution supply and output target for processed solution. This permits recirculation of a batch of solution, or partial recirculation or combination or mixing of the current batch in process with new material if the Supply Feed Pump 401 operates simultaneously with process recirculation.

A third primary circuit discharge valve configuration is possible that permits discharge of processed solution to secondary detention and hydrocyclone separation circuits. To accomplish this, the Process Circulator Return CV 201 and the Processed Flowback Outlet valve 202 are closed and the Detention Circuit Outlet CV 203 is opened. This permits discharge of a batch of process solution or continuous inline process discharge to the detention or hydrocyclone circuit, discussed below.

Once flow at the required rate and/or pressure is established (approximately 2 to 5 fps flow and approximately 1 to 5 psi delivery pressure are likely effective ranges for process recirculation or inline continuous processing) the process solution redirection as described can be implemented as required. Hybrid states where solution is partially discharged to processed solution storage, recirculated or discharged to the secondary process circuits are possible by setting the aforementioned discharge valves to simultaneous partial or totally open states.

Flow rates and discharge pressure from the Process Circulator 417 can be set to accommodate the characteristics of a particular aqueous solution and the piping system ratings and sizes with a minimum flow rate, e.g. approximately 2 fps in the largest diameter pipe for effective inline processing or recirculation.

Use During Processed Aqueous Solution Detention, Precipitate Formation and Detection—Once processed bubble collapse catalyzed conversion of dissolved solids in the aqueous process or wastewater feedstock has begun, a varying interval of detention can to allow precipitate formation and/or precipitate flocculation to an agglomerate particle size suitably large for efficient separation.

To accomplish this, a separate aqueous solution detention circuit for post bubble collapse process reaction catalysis is provided. Often, as a consequence of bubble collapse reactor action, aqueous solution pH and ORP changes permit reactions catalyzed by these aqueous solution state changes to continue post processing. Precipitate formation rates are often increased when the processed solution is detained without agitation in a tank or other vessel. Useful detention intervals vary widely, e.g., from two to seventy-two hours, depending on the nature of the precipitate or complex formed.

Precipitates requiring little or no detention time for effective harvest, such as Fe(OH)₃, may bypass this stage of processing, being diverted directly from bubble collapse reactor processing to hydrocyclone precipitate isolation. Precious metal and other polyatomic complexes may require staged detention and separation with multiple process, detention, and particle separation steps, each with varied operating conditions, sequenced to produce a desired compound, compositional mix or complex in suspension, solution, or as sediment. Subsystems, functional capacity, and automated control are provided as required for all the aforementioned types of processing and other types not contemplated or described herein.

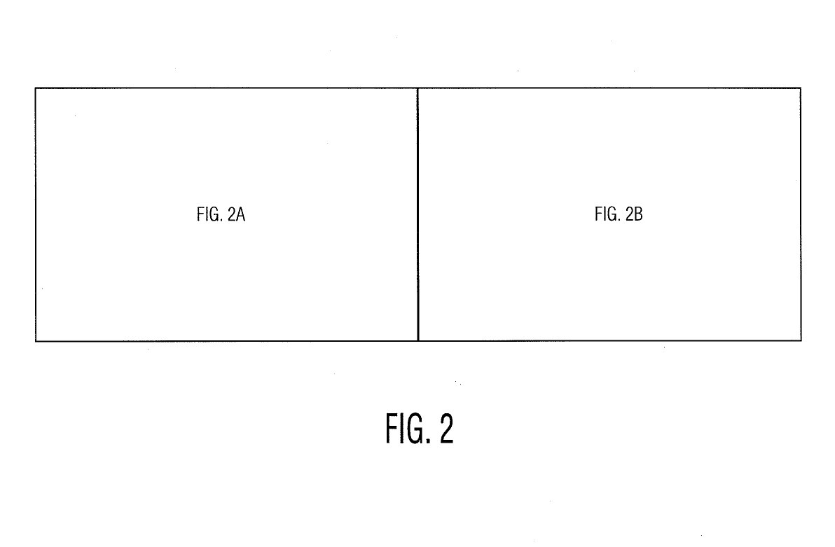

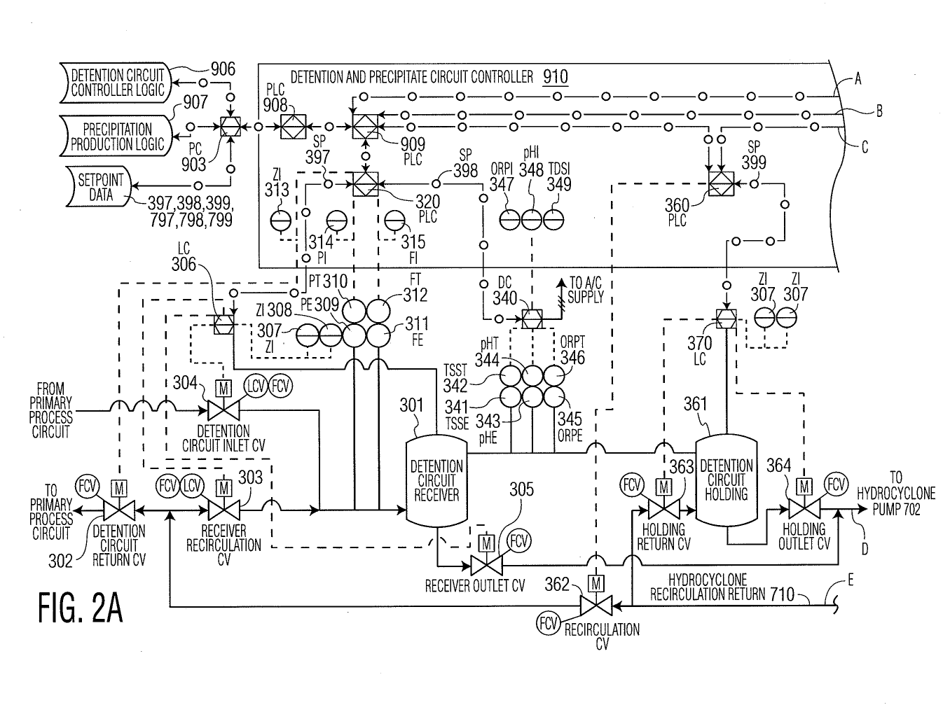

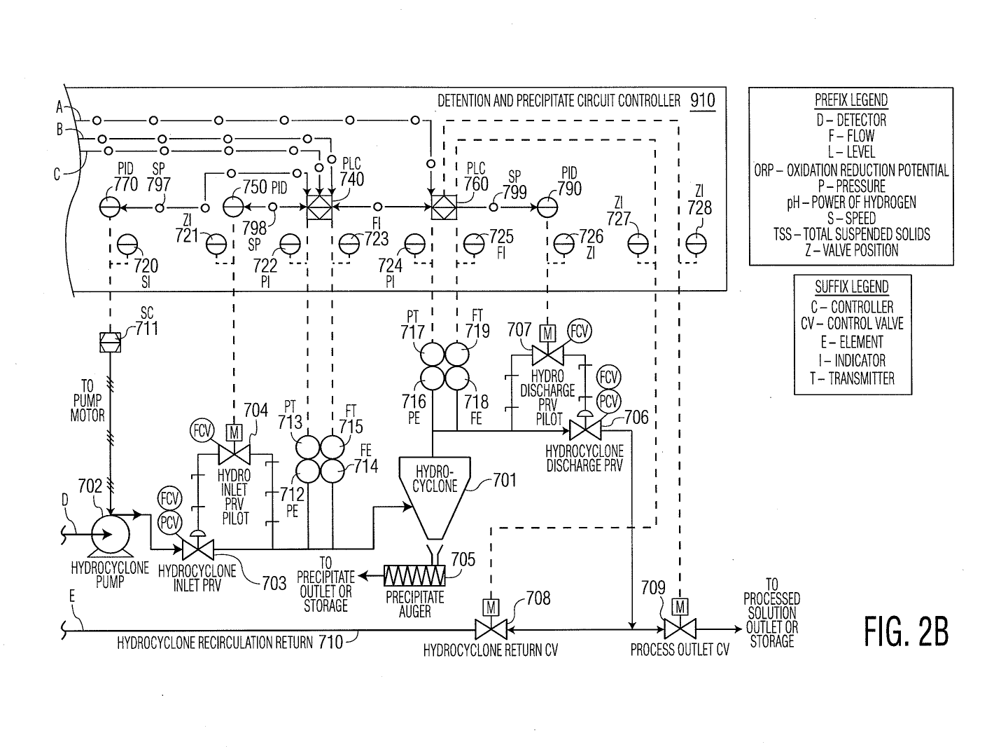

Referring hereinafter to FIGS. 2A-2B except where noted, once processed solution is ready for detention, the Level Controller 306 closes the Receiver Recirculation CV 303 and the Receiver Outlet CV 305 and opens the Detention Circuit Inlet CV 304. Processed aqueous solution is then discharged from the primary process circuit shown in FIGS. 1A-1B by the Process Circulator 417 and flows through the Detention Circuit Inlet CV 304 and into the Detention Circuit Receiver (tank or vessel) 301. The Level Controller 306 measures the level of solution in the Detention Circuit Receiver 301 using a float, ultrasonic or other tank-mounted liquid level detection device (not shown), and measures the incoming process solution pressure and flow, using pressure detector/transmitter PE 309 and PT 310 and flowmeter detector/transmitter FE 311 and FT 312. Processed aqueous solution delivery pressure, flow rate, and total flow are regulated and controlled by modulating the position of the Detention Circuit Inlet CV 304. The Level Controller 306 can also send low or high level, pressure or flow signals through PLC 320 to the Process Circulator Speed Controller 418 (see FIGS. 1A-1B) to direct the Process Circulator 417 (see FIGS. 1A-1B) to increase or decrease speed, start or stop, as required to achieve or maintain a setpoint (SP 397) level, delivery pressure or flow minimum, maximum or range in Detention Circuit Receiver 301.

Once the level in the Detention Circuit Receiver 301 has reached the optimal detention level setpoint (SP 397), the Level Controller 306 sends a signal through PLC 320 to the Process Circulator Speed Controller 418 (see FIGS. 1A-1B) to direct the Process Circulator 417 (see FIGS. 1A-1B) to stop, then closes the Detention Circuit Inlet CV 304, isolating the process solution in the Detention Circuit Receiver 301 at zero flow, ambient pressure and at the last processed temperature. The processed solution can stay in the Detention Circuit Receiver 301 to permit precipitate formation or flocculation.

Measurement of processed solution during detention can be done continuously and can be accomplished with tank-mounted detectors connected to a central detector controller. Detector elements could be tank bulkhead or fixture mountable, immersible and pressure rated according to the expected operating pressures and flows expected in the Detention Circuit Receiver 301 and connecting piping systems. Detector/element combinations can include those for Total Suspended Solids, i.e., TSSE 341 and TSST 342; detector/element combinations for pH, i.e., pHE 343 and pHT 344; oxidation reduction potential, i.e., ORPE 345 and ORPT 346; temperature (TE/TT); dissolved oxygen, CO2, methane, or other soluble gas (not shown); or another solute or solvent compositional or elemental detector, for properly characterize a processing effect on a particular feedstock solution.

The condition of the processed solution in detention can be monitored continuously by the Detector Controller 340, an analog or digital detector transmitter data acquisition/analyzer. A predefined target pH, TSS or ORP, or some combination of values or values ranges as defined by a rule, can be maintained by PLC 320, and serve as the detention termination condition setpoint (SP 398). The termination conditions, once reached, indicate that some additional processing is due as a consequence of the post process and detention aqueous solution state change.

Common state changes in detention include product gas evolution, precipitation of metallic and other ionic species in solution, flocculation and sedimentation of precipitates formed during process or detention, changes in ORP and changes in pH. A change of 1-2 pH or 100 ORP from start of detention would indicate a detention termination condition as these value changes indicate variations in molecular species in suspension or solution, suggesting additional process step application. An increase in TSS in excess of 30 Nephelometric Turbidity Units (“NTU”) indicates the formation of precipitate or flocculent, suggesting solids separation could be effectively applied. A significant drop in TSS, particularly if the detention starting value is 30 NTU or above and the post detention turbidity is <2 NTU, indicates precipitate or flocculent sedimentation has occurred and the process solution is ready to be stripped of solids. Either of these types of changes to suspended solids would be a detention termination condition.

Once detention is complete, Receiver Outlet CV 305 is opened, Hydrocyclone Pump 702 turns on and the process solution is drawn out of the Detention Circuit Receiver 301 through the Receiver Outlet CV 305, into and through the hydrocyclone circuit. If necessary, once the process solution has completed detention, it can be pumped out of the detention receiver and through the hydrocyclone circuit as required for solids separation or redirected back into the primary bubble collapse circuit for additional processing or pumped out to an external process or storage.

Use During Processed Aqueous Solution Precipitate Separation—Once the detention termination conditions (SP 398) are reached, or the detention interval is otherwise terminated, process solution is ready for one of three next steps. The first is separation of precipitates in solution, the second is additional bubble collapse processing, and finally, if no further processing, the solution is discharged.

Further processing can and most likely will consist of stages, with multiple discrete cycles of processing, detention and separation as required to optimally or economically isolate and recover a particular compositional mix of precipitates or polyatomic complexes, enabling better recovery and recycling yields.

To provide this, a separation circuit is designed to accept process solution from multiple sources and to discharge cleared process solution to several targets, depending upon the application and current condition or intended disposition of the processed and cleared solution.

Still referring to FIGS. 2A-2B, the condition of the processed solution in the Detention Circuit Receiver 301 is measured by the tank immersed detector element/transmitters TSSE 341/TSST 342, pHE 343/pHT 344, ORPE 345/ORPT 346. The detector outputs are measured, scaled and compared to a set of values stored in the Detector Controller 340.

If the processed solution's TSS post detention is elevated or its TSS post process was elevated and dropped significantly as a consequence of detention, then it likely contains sufficient solids to justify precipitate or flocculent removal. This can be achieved in one or more passes through the hydrocyclone circuit.

If the precipitate or flocculent consists of large particles or agglomerates or are comprised of relatively massive precipitate particles or polyatomic complexes, it may be technically feasible and desirable to remove a significant percentage of the total suspended solids formed post process or in detention using a single pass through the hydrocyclone circuit.

This method has the advantage of energy savings by reduced pumping. A single pass through the process detention and separation circuits minimizes particle size reduction and dissolution of precipitates caused by hydrodynamic milling resulting from the pressure changes and turbulence encountered in continuous recirculation. This permits a larger particle size cutoff for separation, optimizing the separatory process, and increasing the efficiency of the process. Single pass separation capabilities enable continuous process operation, and system configurations to permit high throughput continuous operation.

When the precipitate particles formed are small, low mass or resist flocculation, an effective solids separation may require some amount of controlled recirculation through the hydrocyclone circuit to achieve production level solids separation efficiency. This method also permits simultaneous recirculation through the primary bubble collapse process circuit, allowing reaction product removal in process, increasing reaction rates and enabling favorable reaction kinetics by continuously removing reaction products. This process method also permits the formation and isolation of separate and unique precipitate compositions, as in-process precipitate removal encourages additional precipitate formation, results in compositional stripping and enables compositional sorting by precipitate formation order, as well as particle size and mass.

To enable implementation of the aforementioned batch, recirculation and continuous flow solids separation techniques, there are at least seven flow path configurations that permit process solution hydrocyclone separation, including at least four batch or discrete recirculation paths and three continuous recirculation or continuous flow-through solids separation and/or processing configurations.

Single Pass Batch Suspended Solids Separation—To perform a single pass separation of a batch of processed solution stored in the Detention Circuit Receiver 301, the process solution is pumped through the hydrocyclone circuit to the Detention Circuit Holding tank 361.

To permit this flow path, the detention circuit receiver Level Controller 306 closes the Detention Circuit Inlet CV 304, closes the Receiver Recirculation CV 303 and opens the Receiver Outlet CV 305. This allows process solution to flow out of the Detention Circuit Receiver 301 through the Receiver Outlet CV 305.

The detention circuit holding control PLC 360 closes the Recirculation CV 362, the detention circuit holding Level Controller 370 closes the Holding Outlet CV 364, and opens the Holding Return CV 363. This prevents reverse flow from the Detention Circuit Receiver 301 to the Detention Circuit Holding tank 361 through or drainage out of the Holding Outlet CV 364 and enables return of process solution from the Hydrocyclone 701 to Detention Circuit Holding tank 361 through Holding Return CV 363.

Hydrocyclone control PLC 760 closes Process Outlet CV 709 and opens Hydrocyclone Return CV 708. This directs the cleared solution Hydrocyclone 701 overflow discharge to be directed through the Hydrocyclone Recirculation Return 710.

Once the Hydrocyclone Pump 702 is started with the valves so set, process solution is drained from the Detention Circuit Receiver 301, through the Hydrocyclone 701 filling Detention Circuit Holding tank 361. The transfer operation ends when the Detention Circuit Receiver 301 is empty or the Detention Circuit Holding 361 has reached the maximum level setpoint (SP 398) as measured and controlled by the detention circuit holding Level Controller 370.

Single Pass Batch Suspended Solids Separation and Reprocessing—Once a batch of process solution is transferred into the Detention Circuit Holding tank 361, it can be passed through the hydrocyclone circuit and returned to the Detention Circuit Receiver 301. A useful process augmentation to this configuration of a single pass batch solids separation is to follow solids separation with another pass through the bubble collapse reactor and chiller. This allows discrete batch reprocessing without recirculation of formed precipitates, enhancing energy usage and preventing reprocessing or dissolution of solids is suspension where this is undesirable.

To permit this flow path, the detention circuit receiver Level Controller 306 opens the Detention Circuit Return CV 302, opens the Detention Circuit Inlet CV 304, closes the Receiver Recirculation CV 303 and closes the Receiver Outlet CV 305. This allows process solution to flow out of the secondary circuit through Detention Circuit Return CV 302 and through the Detention Circuit Inlet CV 304 back into the Detention Circuit Receiver 301, where the batch is held.

The detention circuit holding control PLC 360 opens the Recirculation CV 362, the detention circuit holding Level Controller 370 opens the Holding Outlet CV 364, and closes the Holding Return CV 363. This allows flow through the Recirculation CV 362 without permitting recirculation back into Detention Circuit Holding 361.

Hydrocyclone control PLC 760 closes Process Outlet CV 709 and opens Hydrocyclone Return CV 708. This directs the cleared solution Hydrocyclone 701 overflow discharge to be directed through the Hydrocyclone Recirculation Return 710.

Once the Hydrocyclone Pump 702 is started with the valves so set, process solution is drained from Detention Circuit Holding 361, through the hydrocyclone circuit, out of the secondary circuit to the primary bubble collapse process circuit through the Detention Circuit Return CV 302 and back through the Detention Circuit Inlet CV 304 into the Detention Circuit Receiver 301.

Multiple Pass Discrete Batch Circulation with Suspended Solids Separation—Once a batch of process solution is transferred into the Detention Circuit Holding tank 361, it can be passed through the hydrocyclone circuit and returned to the Detention Circuit Receiver 301, enabling execution of one of the two hereinbefore described single pass batch methods. In this way, a single batch can be passed repeatedly through the hydrocyclone circuit, and during each discrete separation pass, operational parameter values can be varied to permit the formation and/or separation of various precipitate compositions, enabling precipitate compositional sorting and separation by mineral and metal content.

To permit this flow path, the detention circuit holding Level Controller 370 closes the Holding Return CV 363 and opens the Holding Outlet CV 364. This allows process solution to flow out of Detention Circuit Holding 361 through the Holding Outlet CV 364 and out through the hydrocyclone circuit

Detention circuit holding control PLC 360 opens the Recirculation CV 362. Hydrocyclone control PLC 760 closes Process Outlet CV 709 and opens Hydrocyclone Return CV 708. This permits process solution to flow through the hydrocyclone circuit and out of the Hydrocyclone Recirculation Return 710.

The detention circuit receiver Level Controller 306 opens the Receiver Recirculation CV 303 and closes the Detention Circuit Inlet CV 304, the Detention Circuit Return CV 302, and the Receiver Outlet CV 305. This permits flow from the Hydrocyclone Recirculation Return 710 into the Detention Circuit Receiver 301.

Once the Hydrocyclone Pump 702 is started with the valves so set, process solution is drained from the Detention Circuit Holding 361, through the hydrocyclone circuit filling the Detention Circuit Receiver 362. The transfer operation ends when Detention Circuit Holding 361 is empty or the Detention Circuit Receiver 301 has reached the maximum level setpoint (SP 398) as measured and controlled by the detention circuit receiver Level Controller 306.

By alternately pumping the process solution from the Detention Circuit Receiver 301 through the hydrocyclone to Detention Circuit Holding 361, and then reconfiguring to pump from the Detention Circuit Holding 361 through the hydrocyclone circuit back to the Detention Circuit Receiver 301, it is possible to run a batch through the hydrocyclone in a discrete pass as many times as required.

This configuration also permits storage of a process solution batch in the Detention Circuit Holding 361. Processing of another batch using the Detention Circuit Receiver 301 can be carried out using recirculation or a flow through processing configuration without disturbing a batch stored in Detention Circuit Holding 361 by closing the Holding Return CV 363 and the Holding Outlet CV 364 as this permits bypass flow from the Receiver Outlet CV 305 through to the Hydrocyclone Pump 702 and hydrocyclone circuit.

Detention Circuit Receiver Recirculation and Suspended Solids Separation—Once a batch of process solution is transferred into the Detention Circuit Receiver 301, it can be passed through the hydrocyclone circuit and returned to the Detention Circuit. Receiver 301,, permitting continuous recirculation and solids separation.

To permit this flow path, the detention circuit receiver Level Controller 306 closes the Detention Circuit Return CV 302, closes Detention Circuit Inlet CV 304, opens the Receiver Recirculation CV 303 and opens the Receiver Outlet CV 305. This allows process solution to flow into the Detention Circuit Receiver 301 through the Receiver Recirculation CV 303 and out the Receiver Outlet CV 305.

The detention circuit holding Level Controller 370 closes the Holding Outlet CV 364 and closes the Holding Return CV 363. This prevents flow from the Detention Circuit Receiver 301 to the Detention Circuit Holding 361 through the Holding Outlet CV 364.

Hydrocyclone control PLC 760 closes Process Outlet CV 709 and opens Hydrocyclone Return CV 708. This directs the cleared solution Hydrocyclone 701 overflow discharge to be directed through the Hydrocyclone Recirculation Return 710.

Once the Hydrocyclone Pump 702 is started with the valves so set, process solution is pumped from the Detention Circuit Receiver 301, through the hydrocyclone circuit and back through the Hydrocyclone Recirculation Return 710, through the Recirculation CV 362, through the Receiver Recirculation CV 303 and back into the Detention Circuit Receiver 301. Recirculation is ended by stopping the Hydrocyclone Pump 702, or by redirecting the process solution out of the detention or hydrocyclone circuit by opening the Process Outlet CV 709 or opening the Detention Circuit Return CV 302 or into the Detention Circuit Holding 361 by opening the Holding Return CV 363 and closing the Recirculation CV 362.

Detention Circuit Holding Recirculation and Suspended Solids Separation—Once a batch of process solution is transferred into Detention Circuit Holding 361, it can be passed through the hydrocyclone circuit and returned to Detention Circuit Holding 361, permitting continuous recirculation and solids separation.

To permit this flow path, the detention circuit receiver Level Controller 306 closes Receiver Outlet CV 305. This prevents reverse flow through the Receiver Outlet CV 305 into the Detention Circuit Receiver 301 as process solution flows through the Holding Outlet CV 364 into and out of the Hydrocyclone Pump 702.

The detention circuit holding control PLC 360 closes Recirculation CV 362. Level Controller 370 opens the Holding Return CV 363 Holding Outlet CV 364. This permits flow out of Detention Circuit Holding 361 through the Holding Outlet CV 364 and back into Detention Circuit Holding 361 through Holding Return CV 363.

Hydrocyclone control PLC 760 closes Process Outlet CV 709 and opens Hydrocyclone Return CV 708. This directs the cleared solution Hydrocyclone 701 overflow discharge to be directed through the Hydrocyclone Recirculation Return 710.

Once the Hydrocyclone Pump 702 is started with the valves so set, process solution is pumped from Detention Circuit Holding 361, through the hydrocyclone circuit and back through the Hydrocyclone Recirculation Return 710, through the Holding Return CV 363 and back into Detention Circuit Holding 361. Recirculation is ended by stopping the Hydrocyclone Pump 702, or by redirecting the process solution out of the detention or hydrocyclone circuit by opening the Process Outlet CV 709 or opening the Detention Circuit Return CV 302 or into the Detention Circuit Receiver 301 by closing the Holding Return CV 363 and opening the Recirculation CV 362 and opening the Receiver Recirculation CV 303.

Primary Circuit Recirculation with Suspended Solids Separation—Once a batch of process solution is transferred into the Detention Circuit Receiver 301, it can be passed through the hydrocyclone circuit and returned to the Detention Circuit Receiver 301 after passing back into, through and out of the primary bubble collapse processing circuit, permitting continuous recirculation during bubble collapse processing and solids separation.

To permit this flow path, the detention circuit receiver Level Controller 306 opens the Detention Circuit Return CV 302, closes the Receiver Recirculation CV 303, opens the Detention Circuit Inlet CV 304, and opens the Receiver Outlet CV 305. This allows process solution to flow out of the Detention Circuit Receiver 301 through the hydrocyclone circuit, out of the secondary circuit to the primary circuit through the Detention Circuit Return CV 302 and back from the primary circuit through the Detention Circuit Inlet CV 304 and back into the Detention Circuit Receiver 301.

The detention circuit holding control PLC opens Recirculation CV 362. The detention circuit holding Level Controller 370 closes the Holding Outlet CV 364 and closes the Holding Return CV 363. This prevents flow from the Detention Circuit Receiver 301 to the Detention Circuit Holding 362 through the Holding Outlet CV 364 and permits return flow through the Hydrocyclone Recirculation Return 710 and out of the secondary circuits.

Hydrocyclone control PLC 760 closes Process Outlet CV 709 and opens Hydrocyclone Return CV 708. This directs the cleared solution Hydrocyclone 701 overflow discharge to be directed through the Hydrocyclone Recirculation Return 710.

Once the Hydrocyclone Pump 702 is started with the valves so set, process solution is pumped from the Detention Circuit Receiver 301, through the hydrocyclone circuit and back through the Hydrocyclone Recirculation Return 710, through the Recirculation CV 362, through the Detention Circuit Return CV 302, out to and through the primary bubble collapse process circuit and back into the Detention Circuit Receiver 301 from the primary circuit through the Detention Circuit Inlet CV. Recirculation is ended by stopping the Hydrocyclone Pump 702, or by redirecting the process solution out of the detention or hydrocyclone circuit by opening the Process Outlet CV 709 or into the Detention Circuit Holding 361 by opening the Holding Return CV 363 and closing the Recirculation CV 362.

Flow Through Continuous Processing with Suspended Solids Separation—When maximum productivity and scalability are implemented, the optimal process routing is into the primary circuit from an external supply, bubble collapse processing to catalyze precipitate formation followed by immediate separation of suspended solids and discharge of the processed and solids stripped solution out to an external process or storage.

To permit this flow path, the detention circuit receiver Level Controller 306 closes the Receiver Recirculation CV 303, opens the Detention Circuit Inlet CV 304, and opens the Receiver Outlet CV 305. This allows process solution to flow into the Detention Circuit Receiver 301 through the through the Detention Circuit Inlet CV 304 and out to the hydrocyclone circuit.

The detention circuit holding Level Controller 370 closes the Holding Outlet CV 364. This prevents flow from the Detention Circuit Receiver 301 to the Detention Circuit Holding 362 through the Holding Outlet CV 364.

Hydrocyclone control PLC 760 opens Process Outlet CV 709 and closes Hydrocyclone Return CV 708. This directs the cleared solution Hydrocyclone 701 overflow discharge to be directed through the Process Outlet CV 709 and out of the system.

Once the Hydrocyclone Pump 702 is started with the valves so set, process solution is pumped from the Detention Circuit Receiver 301, through the hydrocyclone circuit and out of the system through the Process Outlet CV 709.

The Hydrocyclone Circuit—Once process solution flows from one of the aforementioned solution sources to the Hydrocyclone Pump 702, control of process solution delivery pressure and flow is monitored and directed by the hydrocyclone circuit control PLCs 740 and 760.

Referring hereinafter to FIGS. 2A-2B except where noted, once processed solution is ready for precipitate separation, as indicated by changes in turbidity, pH, ORP or another processed solution parameter value measured in the Detention Circuit Receiver 301 or Detention Circuit Holding 361, it is pumped by from the source vessel by the Hydrocyclone Pump 702 through the hydrocyclone circuit. The speed of the Hydrocyclone Pump 702, and consequently the maximum pressure and flow (SP 797), are controlled by the hydrocyclone pump's Speed Controller 711.

Continuing downstream from the Hydrocyclone Pump 702, processed aqueous solution passes through the Hydrocyclone Inlet PRV 703, which, piloted by the Hydro Inlet PRV Pilot 704, and measured by pressure and flow detectors/transmitters PE 712/PT 713 and FE 714/FT 715 installed immediately downstream of the Hydrocyclone Pump 702, maintains the target delivery pressure and flow rate (SP 798) required by the Hydrocyclone 701 to provide the cutoff particle size separation desired.

Particles of the desired size or mass settle to the bottom of the Hydrocyclone 701 where periodically they are discharged through a precipitate outlet valve (not shown) and are transported by the Precipitate Auger 705 as required to an external dryer, container or other external storage (not shown).

Process solution partially or totally cleared of precipitate is discharged out of the Hydrocyclone 701 overflow and passes through the Hydrocyclone Discharge PRV 706, which, piloted by the Hydro Discharge PRV Pilot 707, and measured by pressure and flow detectors/transmitters PE 716/PT 717 and FE 718/FT 719 installed immediately downstream of the Hydrocyclone 701, maintains the target discharge pressure and flow rate (SP 799) required by the Hydrocyclone 701 to provide the cutoff particle size separation desired.

Hydrocyclone 701 circuit inlet control PLC 740 and discharge control PLC 760 communicate with each other and with the Hydrocyclone Pump 702 Speed Controller 711, permitting on the fly inlet and discharge flow and pressure fine tuning and modifications as required to sustain separation of the particle size or mass cutoff desired, even as conditions of mean particle size and suspended particle density or turbidity are changed by processing or hydrocyclone action. Once cleared process solution exits the hydrocyclone circuit through Hydrocyclone Discharge PRV 706. Subsequent process solution flow is redirected as described hereinbefore by downstream valve operation as controlled by the hydrocyclone discharge control PLC 760.

The Control Systems and Components of the Integration Subsystem—Referring to FIGS. 1-2, the Controllers 900 and 910 provide subsystem and component operation condition detection and control functions and services. The components of the Controllers, the device control and state detection sensors and the signal processing devices used to interconnect the sensors, together, comprise the extensible, componentized Integration Subsystem. The primary control algorithms, system operation and detection sequencing instructions and setpoints or setpoint algorithms, are stored in external controller PC 903 which can be a personal computer (“PC”), Panel-PC, PLC or some other specific purpose programmable human-machine interface (“HMI”) device or controller. An example of a suitable commercially available PLC is Allen-Bradley Micrologix 1400 Model 1766-L32BWAA. An example of a suitable commercially available PLC software with PID algorithms is RSLogix 500 Professional. An example of a suitable commercially available PC is HP Compaq dx2450. The PC 903 can communicate with the PLC 905 by way of PLC 904.

Each subsystem has a primary or central controller or device that serves to interface and communicate the control and state data signals between the subsystem and the Controller PC 903. Communication topology and signal types should be standardized in the pathway between the various subsystem interface or control devices and the Controller PC 903, and can be 4-20 ma, 0-5 vdc, serial Ethernet, Ethernet or some other industry standardized signal and data communication standard. Communications methods between the individual subsystems and the controllers, controlling devices or Controller 900 and 910 interfaces can vary as required by the particular subsystem components. Communication between subsystems and the Controller PC 903 are preferrably of the same type, and each subsystem preferrably has a standard interface type. In this way, substitute, replacement, or additional subsystems with variable features or capacities can be incorporated into the system without modification to other unaffected subsystem controls or control interfaces, including the Controllers 900 and 910 themselves, the Controller PC 903 and its algorithms, or the Integration Subsystem.

The Controllers 900 and 910 oversee and marshal interoperation between multiple interconnected subsystems and have several specific intrinsic functions as are required to direct interdependent operation of the subsystems.

The Primary Circuit Controller 900 directs and detects the operation and state of pumps, valves, vessels and the bubble collapse reactor. The Primary Circuit Controller 900 provides motor control functions for the Supply Feed Pump 401, the Process Circulator 417, and the Fuel Gas Transfer Pump 502. As a motor controller, it receives or generates and subsequently transmits the motor start, stop and other variable frequency drive or speed controller function commands and data, including the pump motor speed setpoint (497, 499, 597) signals to the Supply Feed Pump 401 Speed Controller 402 and proportional-integral-derivative (“PID”) 430, the Process Circulator 417 Speed Controller 418 and PID 440, and to the Fuel Gas Transfer Pump 502 Speed Controller 503 and PID 505.

In conjunction with pump speed control, the Primary Circuit Controller 900 maintains vessel level control and process solution pressure and flow control. It generates or transmits the minimum and maximum Process Supply 411 process solution level setpoint (SP 498) to the Process Supply 411 Level Controller 406, which manipulates the motorized Supply Level Control Valve 405, a globe or pilot actuated diaphragm valve, so that the setpoint level is maintained. When the Process Supply 411 level is below minimum, the Level Controller 406 opens the Supply Level Control Valve 405. If delivery pressure or flow is too low to maintain or satisfy the low level setpoint in the Process Supply 411, as measured by pressure and flow detectors/transmitters PE 407/PT 408 and FE 409/FT 410, Level Controller 406 sends a request to PLC 420 for an increase in Supply Feed Pump 401 speed setpoint (SP 497). If the level in the Process Supply 411 is at setpoint, the Level Controller 406 sends a signal to PLC 420 to stop the Supply Feed Pump 401 and closes the Supply Level Control Valve 405. In this way, the Process Supply 411 level can be maintained independently of and at the level required by the Process Circulator 417.

The Primary Circuit Controller 900 also controls the Bubble Collapse Reactor 601 operation, monitoring and maintaining the process solution conditions required to establish or sustain a particular operational state within the Bubble Collapse Reactor 601. Process solution delivery pressure and flow are measured by pressure and flow detectors/transmitters PE 104/PT 105 and FE 106/FT 107, and monitored by PLC 140, which maintains the setpoint pressure or flow (SP 197) through operation of the Reactor Inlet PRV 102 by modulating the Inlet PRV Pilot 103. The PLC 140 transmits a PID 150 to the Inlet PRV 103. When pressure or flow are below the setpoint (SP 197) due to insufficient Process Circulator Discharge 101 pressure or flow, PLC 140 sends a signal to PLC 420 to increase the Process Circulator 417 speed setpoint (SP 499). In this way, process solution flow and pressure are maintained as required for Bubble Collapse Reactor 601 operation independently of Process Supply 411 level or Supply Feed Pump 401 operation.

The Primary Circuit Controller 900 can operate with or without an advanced process controller outfitted Bubble Collapse Reactor 601. When the Bubble Controller 602 calculates and controls the operational parameter values of the Bubble Collapse Reactor 601, then PLC 620 transmit a setpoint operational target (SP 697) and PID 630 to BC 602, and will receive from BC 602 its calculated pressure, flow, temperature, ORP, pH, DO, TDS, TSS or other parametric aqueous solution values that are required to achieve the operational target setpoint (SP 697). In this case, PLC 620 will relay the pressure and flow values to PLC 140 and PLC 420 to be used to control Reactor Inlet PRV 102 and the Process Circulator 417 and will relay detector and temperature targets and setpoints to PLC 160. PLC 160 will read temperature and other detector values reported by temperature detector/transmitter TE 123/TT 124 and the Detector Controller 119, relaying these values back to PLC 620 for transmission as PV's back to the Bubble Controller 602. In this way, the PLC 620 serves as an information relay and conduit for an intelligent or advanced version of a Bubble Controller 602, where the Bubble Collapse Reactor is so outfitted. The PLC 160 transmits PID 180 to the SC 142, and transmits PID 170 to the Discharge PRV 128.

Where the Bubble Controller 602 has no capacity to direct or calculate required process solution delivery pressure, flow, temperature or the optimal conditions required for Bubble Collapse Reactor 601 operation as measured by the Detector Controller 119, then PLC 620 receives or generates a setpoint power or other parametric value as required to operate the Bubble Collapse Reactor 601 and transmits this setpoint (SP 697) to the Bubble Controller 602. PLC 620 monitors and controls process solution delivery pressure, flow and temperature directly and communicates with the Detector Controller 119, retrieving process solution changes as measured by the Detector Controller 119 connected detectors. PLC 620 then recalculates and retransmits to the Bubble Controller 602 the parametric value setpoint (SP 697) used to direct the Bubble Collapse Reactor 601 operation. In this way, the Primary Circuit Controller 900 component PLCs can calculate and direct system operation to achieve optimal Bubble Collapse Reactor 601 function where the Bubble Controller 602 is not capable of controlling, calculating or transmitting target process variable values as required for closed loop Bubble Collapse Reactor 601 control.

During recirculating primary or secondary circuit processing, the Bubble Collapse Reactor 601 action and operation will require temperature reduction for control.

Process solution temperature is measured by temperature detector/transmitter TE 123/TT 124. This process variable is used in conjunction with a temperature or Chiller 141 performance setpoint (SP 198). The temperature PV is read by PLC 160 which calculates either a target temperature or performance value and transmits this calculated setpoint (SP 198) to the Chiller 141 Speed Controller (142). The Chiller 141 Speed Controller (142) will modulate either refrigerant capacity, coolant recirculation, or some other value or combination of functions so as to achieve either the performance or process solution target temperature transmitted as its operational setpoint (SP 198).

Once aqueous solution has been processed in the Bubble Collapse Reactor 601, product gases such as methane or other alkane fuel gases will form and extraction of these may be desired. The Primary Circuit Controller 900 also directs the operation of the valves and pump required to perform processed solution product gas extraction. Aqueous processed solution product gas removal can occur in a single pass or during recirculation. Aqueous solution discharged from the Bubble Collapse Reactor 601, passes through the Chiller 141 at a pressure and flow as controlled by Process Circulator 417 speed and Reactor Inlet PRV 102 position. This pressure, likely between 2 psi and 100 psi or more will be too high to permit effective off-gassing or gas-liquid separation. To permit productive off-gassing and separation, PLC 160 operates the Reactor Discharge PRV 127 through pilot control Discharge PRV Pilot (128), reducing the discharge pressure and flow of process solution to a lower pressure or flow setpoint (SP 199) as required to allow dissolved gases to come out of solution. The depressurized solution then passes into a gas liquid separator, which can be a closed tank, weir or other apparatus designed to permit or encourage gas separation through flow pattern controls. PLC 504 monitors the Gas Liquid Separator 501 headspace gas pressure and fuel gas concentration as measured by pressure detector/transmitter PE 508/PT 509 and methane detector/transmitter ME 506/MT 507. The separator 501 could include a drain 514 and associated valve. Once the target fuel gas concentration and pressure are attained, PLC 504 signals to PLC 905 a flow ready condition, PLC 905, according to Primary Circuit Controller Logic 901 and TDS Reduction Logic 902 directs PLC 220 to operate a discharge valve, PLC 504 sends a start signal and calculates a target setpoint Fuel Gas Transfer Pump 502 speed (SP 597) which it transmits to Speed Controller 503. The headspace gases of the Gas Liquid Separator 501 are in this way removed continuously at a rate controlled by the concentration of the fuel gases in the headspace gas mix. Gases removed from the process solution in this way are discharged out of the system and are separated for recovery and recycling using gas filters or other gas isolation apparatus (not shown).

The final responsibility of the Primary Circuit Controller 900 is flow control after bubble collapse processing and gas separation. As hereinbefore described, there are multiple possible routings of process solution, as required to process a particular aqueous composition and state. Accordingly, it is possible to redirect process solution after gas separation, permitting recirculation, transfer to the detention or separatory circuit, or discharge out of the system.

PLC 220 operates the valves controlling processed solution routing according to Primary Circuit Controller Logic 901 and TDS Reduction Logic 902 as communicated to it from PLC 905. For process solution recirculation, PLC 220 closes Process Outlet 202, Detention Circuit Outlet CV 203 and Detention Circuit Return CV 204 and opens Process Circulator Return CV 201. This permits aqueous solution to flow out of the Gas Liquid Separator 501 through the Process Circulator Return 132 back into the Process Supply 411. If processing is complete, PLC 220 closes the Detention Circuit Outlet CV 203 and the Process Circulator Return CV 201 and opens the Process Outlet 202, and the process solution is pumped out of the primary circuit by the Process Circulator 417 to an external process or receiver (not shown). To permit process detention or separation, PLC 220 directs aqueous solution to the secondary circuit by closing the Process Outlet 202 and the Process Circulator Return CV 201 and opening the Detention Circuit Outlet CV 203. To permit recirculation from the detention circuit back into the primary circuit, PLC 220 opens the Detention Circuit Return CV 204, and process solution pumped into the secondary circuit can be returned to the primary circuit through the action and control of the secondary circuit apparatus.

It is noted that the controller 900 can indicate various system conditions such as speed, pressure, flow, valve conditions, temperatures, power, TDS, pH, ORP, methane levels, and other parameters, using data obtained from associated sensors. While the sensors are shown as discrete devices, the sensors could be a single device. Values sent from transmitters are shown to users on indicators, which can be local or remote gauges or computer graphical monitors. An example of a suitable commercially available pressure sensor/transmitter is Ashcroft Xmitr, 0-100 psi, 3″. As shown in FIGS. 1A-1B, these indications could include, but are not limited to, speed indicator 413, pressure indicator 414, flow indicator 415, speed indicator 416, valve position indicator 110, pressure indicator 111, temperature indicator 112, power indicator 603, oxidation reduction potential indicator 120, pH indicator 121, total dissolved solids indicator 122, speed indicator 143, temperature indicator 129, valve position indicator 131, pressure indicator 130, methane indicator 510, pressure indicator 511, speed indicator 512, and valve position indicators 205, 206, 207 and 208. Such indications could be conveyed by the way of dials, lights, light-emitting diodes (LEDs), graphical user interface (GUI) readouts, digital displays, liquid crystal displays (LCDs), or any other suitable devices for conveying the aforementioned information. Further, indicators are not required and/or may function to only indicate information for internal controller use.

Referring hereinafter to FIGS. 2A-2B unless otherwise noted, the Detention and Precipitate Circuit Controller 910 directs and detects the operation and state of pumps, valves, detention vessels and the hydrocyclone subsystem circuit. The Detention and Precipitate Circuit Controller 910 provides motor control functions for the Hydrocyclone Pump 702. As a motor controller, it receives or generates and subsequently transmits the motor start, stop and other variable frequency drive or speed controller function commands and data, including the pump motor speed setpoint (797) signals to the Hydrocyclone Pump 702 Speed Controller 711 and PID 770.

In conjunction with pump speed control, the Detention and Precipitate Circuit Controller 910 is responsible for storage and routing of process solution after bubble collapse processing, according to the multiple post bubble collapse process options hereinbefore described.

The first task of the Detention and Precipitate Circuit Controller 910 is routing of process solution from the primary bubble collapse reactor process circuit. PLC 320 receives a signal from the Primary Circuit Controller 900 (see FIGS. 1A-1B) through PC 903 or PLC 908 that process solution is ready for discharge into the secondary circuit and directs the Detention Circuit Receiver 301 Level Controller 306 to open the Detention Circuit Inlet CV 304 and close the Receiver Recirculation CV 303 and the Receiver Outlet CV 305. The Level Controller 306 monitors the process solution level in the Detention Circuit Receiver 301 while PLC 320 monitors the delivery pressure and flow as measured by pressure and flow detectors/transmitters PE 309/PT 310 and FE 311/FT 312. Once the target maximum level (SP 397) is reached in the Detention Circuit Receiver 301, PLC 320 signals the Primary Circuit Controller 900 (see FIGS. 1A-1B) to stop solution delivery and signals Level Controller 306 to close the Detention Circuit Inlet CV 304. This permits feed control into the secondary process circuits independent of primary bubble collapse process circuit operation.

Process solution in the Detention Circuit Receiver 301 or Detention Circuit Holding 361 is monitored by the Detector Controller 340 and its array of tank mounted sensors, which includes but may not be limited to detectors for TSS, TDS, pH, ORP, DO, or some other parametric value useful for measurement of processed solution condition in one of the detention tanks. PLC 320 communicates with Detector Controller 340, comparing its detention termination setpoint condition values (SP 398) with those process variables monitored and transmitted to it by the Detector Controller 340.

Once the detention interval termination conditions (SP 398) have been reached, PLC 320 signals Level Controller 306 to open the Receiver Outlet CV 305, then signals PLC 360 to close the Holding Outlet CV 364, and then signals PLC 740 to start the Hydrocyclone Pump 702, pumping process solution out of the Detention Circuit Receiver 301.

According to Detention Circuit Controller Logic 906 and Precipitation Production Logic 907, and as required to separate the desired particle or flocculate from solution by particle size and/or mass, PLC 740 calculates and transmits through PID 770 to Speed Controller 711 the Hydrocyclone Pump 702 speed setpoint (SP 797) and through PID 750 to Hydro Inlet PRV Pilot 704 the valve position of the Hydrocyclone Inlet PRV 703 required to maintain a particular delivery pressure or flow (SP 798) at the Hydrocyclone 701 inlet. Hydrocyclone 701 inlet pressure and flow rate are monitored by PLC 760 as measured by pressure and flow detectors/transmitters PE 712/PT 713 and FE 714/FT 715. If the measured flow or pressure are below the setpoint (SP 798) minimum required for desired Hydrocyclone 701 operation, PLC 760 transmits this low condition to PLC 740, which in turn recalculates and transmits to Speed Controller 711 a new Hydrocyclone Pump 702 speed setpoint (SP 797) as required to meet the minimum delivery flow and pressure setpoint (SP 798).

Hydrocyclone 701 outlet pressure and flow are controlled independently by PLC 760, regulating and fine tuning cutoff size separation. PLC 760 calculates and transmits through PID 790 to Hydro Discharge PRV Pilot 707 the valve position of the Hydrocyclone Discharge PRV 706 required to maintain a particular step down pressure or flow (SP 799) at the Hydrocyclone 701 overflow outlet. Hydrocyclone 701 process solution discharge pressure and flow rate are monitored by PLC 760 as measured by pressure and flow detectors/transmitters PE 716/PT 717 and FE 718/FT 719. If the measured flow or pressure are below the setpoint (SP 799) minimum required to sustain the required cutoff particle size or mass, PLC 760 transmits this low condition to PLC 740, which in turn recalculates and transmits to Speed Controller 711 a new Hydrocyclone Pump 702 speed setpoint (SP 797) or a new Hydrocyclone Inlet PRV 703 position (SP 798) as required to meet the minimum overflow process solution discharge flow and pressure setpoint (SP 799).

Periodically, according to total gallons processed or mass of precipitate accumulated as determined with optical or mass measurements using a strain gauge or similar detector (not shown), PLC 760 will open a butterfly, ball or other type of precipitate dump valve (not shown) allowing accumulated precipitate to drop into the Precipitate Auger 705, which will transport the accumulated precipitate to a rotary oven, kiln, storage shed, bin, or other post separation process or storage.

As with the Primary Circuit Controller 900, the final Detention and Precipitate Circuit Controller 910 control function is routing of processed solution after a separation pass through the hydrocyclone circuit. As explained hereinbefore, multiple pathways are possible, permitting recirculation through part or all of the system, additional processing, detention, or discharge.

PLC 760 has primary control over post hydrocyclone circuit routing. PLC 760 closes the Hydrocyclone Return CV 708 and opens Process Outlet CV 709 when signaled by secondary circuit master PLC 909; this directs all Hydrocyclone 701 discharge to an external process or storage. This is the valve position for all through processing using the hydrocyclone circuit or a detention vessel.

When directed, to permit all reprocessing and recirculation options, PLC 760 closes the Process Outlet CV 709 and opens the Hydrocyclone Return CV 708. This returns process solution after discharge from the hydrocyclone circuit to another circuit or subsystem.

PLC 360 communicates with Level Controller 370 when Detention Circuit Holding 361 is in use and operates its valves according to flow path and transfilling request from PLC 909 while respecting the minimum and/or maximum process solution level in Detention Circuit Holding 361 specified by the level setpoint (SP 399). PLC 360 closes Recirculation CV 362 and opens Holding Return CV 363 to permit flow into Detention Circuit Holding 361. PLC 360 opens Holding Outlet CV 364 to permit flow, hydrocyclone circuit recirculation, or bubble collapse reprocessing, of process solution stored in Detention Circuit Holding 361.

PLC 320 controls flow once permitted out of the hydrocyclone or detention circuits through the Recirculation CV 362. PLC 320 communicates with Level Controller 306 when the Detention Circuit Receiver 301 is in use and directs valve operation according to flow path and transfilling request from PLC 909 while respecting the minimum and/or maximum process solution level in the Detention Circuit Receiver 361 specified by the level setpoint (SP 397). PLC 320 closes the Detention Circuit Return CV 302 directs Level Controller 306 to open Receiver Recirculation CV 303 and close Detention Circuit Inlet CV 304 to permit detention or recirculation of hydrocyclone circuit discharge, directing flow into the Detention Circuit Receiver 301. PLC 360 opens Detention Circuit Return CV 302 and directs LC 306 to close Receiver Recirculation CV 303 and open Detention Circuit Inlet CV 304 to permit recirculation of process solution out of the hydrocyclone circuit and back to the primary circuit to permit additional bubble collapse processing or process solution cooling. To allow single pass or flow through processing using the primary and secondary circuits, PLC 320 opens the Detention Circuit Return CV 302 directs Level Controller 306 to close the Receiver Recirculation CV 303 and open Detention Circuit Inlet CV 304. Redirection of process solution can occur during operation, and hybrid flow paths permitting multiple source and target pathways are possible where such arrangements could provide additional capabilities or increase throughput.

It is noted that the controller 910 can indicate various system conditions such as speed, pressure, flow, valve conditions, temperatures, power, TDS, pH, ORP, and other parameters. As shown in FIGS. 2A-2B, these indications could include, but are not limited to, valve position indicators 307, 308, and 313, pressure indicator 314, flow indicator 315, oxidation reduction potential indicator 347, pH indicator 348, total dissolved solids indicator 349, speed indicator 720, flow indicator 721, pressure indicator 722, flow indicator 723, pressure indicator 724, flow indicator 725, and valve position indicators 726, 727 and 728. Such indications could be conveyed by the way of dials, lights, light-emitting diodes (LEDs), graphical user interface (GUI) readouts, digital displays, liquid crystal displays (LCDs), or any other suitable devices for conveying the aforementioned information. Further, indicators are not required and/or may function to only indicate information for internal controller use.

The Primary Circuit Controller Logic 901 and Detention Circuit Controller Logic 906 stored and executed by the Controllers 900 and 910 provides operational sequence, valve control, vessel level control, pump control, detector control and other functions. This logic can be changed as required to include functions specific to a particular configurations. FIGS. 1 and 2 show exemplary sets of detectors/transmitters and subsystem controlling devices for implementing the operational methods explained herein. Other configurations are possible using equipment, detectors and controllers not shown, or omitting or combining some of the included apparatus subsystems or components.

Accommodating these possible physical configuration, the Logic 901 and 906—i.e., those programming instructions pertaining to system and device identification, state detection, control and task distribution for Controllers 900 and 910—can be uploaded to an external computer or device, e.g., PC 903, for storage, required modification and subsequent download back to the Controllers 900 or 910. Alternately, separate instances of configuration-specific Controller 900 or 910 logic can be stored locally in one of the Controllers 900 or 910, or in an external computer or device (e.g., PC 903) to be uploaded or executed as required. Additionally, it may be necessary to change the operational sequence for a particular application. The TDS Reduction Logic 902 or Precipitation Production Logic 907 are algorithms that control process routing, pump, valve and reactor operation based on detected solution changes, the order of sensor or detector evaluation, the order of setpoint modification, the setpoint values and algorithms for setpoint modification, or algorithms used to identify and recover from operational fault states. They may be stored in or are accessible to and executed on components installed in either Controller 900 or 910. As with Controller Logic, either 901 or 906, a unique version of application logic, 902 or 907, can be stored locally within one of the Controllers 900 or 910, or on an external device, e.g., PC 903. Alternately, application logic 902 or 907 can be uploaded to an external device or computer, e.g., PC 903, modified, and then downloaded with changes to one of the Controllers 900 or 910. In this way, alternate process sequencing or algorithms can be dynamically loaded, permitting both planned and on the fly changes to application or controller logic, enhancing the flexibility and applicability.

Setpoint data describing operational parameter values such as pump speed, vessel level, valve position, delivery pressure or flow, step down pressure or flow, process or step termination conditions as measured by detectors, reactor power, temperature and others parameter that are provided as individual values, independent or dependent values or value ranges or algorithms used to calculate values or value ranges, are stored with or accessible to Controllers 900 and 910 and can be uploaded and downloaded to an external device or computer, e.g., PC 903. In each case, where data or program code stored in or accessible to a Controller 900 or 910 is to be modified, rather than uploading, modifying and downloading existing setpoint data items or application logic, it is also possible to access and modify the information on or accessible to one of the Controllers 900 and 910 directly using an external device or computer, e.g., PC 903 or another (not shown). In addition, an operator control panel (not shown), human machine interface (not shown) or graphical computer monitor (not shown) can be provided to allow partial or totally manual control, entry of setpoint data, manipulation of or interaction with Controller or application logic, or manual control of subsystems or components directly.

Note that although FIGS. 1-2 depict discrete Controllers 900 and 910, external computer PC 903 and other specific purpose controllers (SC 402, LC 406, SC 418, LC 306, BC 602, DC 119, SC (142), SC 503, LC 306, DC 340, LC 370, and SC 711), these functions could be combined in a single special purpose controller, PLC, PC or other similar device. In addition, while Controllers 900 and 910 are shown in FIGS. 1-2 to incorporate multiple discrete PLC and PID into a single controller, devices performing these functions could be installed in separate locations as part of separate controllers. This alternate control component arrangement is likely where the system is incorporated into a larger overall process or system. Also, while controller logic 901, 906 and application logic 902, 907 are depicted in FIGS. 1-2 as residing in and executing within the Controllers 900 and 910, it is possible that the controller logic 901, 906, could reside in and execute on a different controller, PC, PLC, or other similar device than the one that stores and runs application logic 902, 907, and these separate control, PC, PLC, or alternate devices could also reside in separate controllers. Similar variation in component function distribution, grouping or placement is also possible with the other detector element s/ transmitters or indicator devices. The Controller 900 and 910 component arrangements and functions rendered in FIGS. 1-2 are examples of stand-alone, self-contained operation and control of the system, for use as depicted when the system is configured and connected upstream and downstream as shown, or as a design feature guide for different physical configurations, such as where the system is incorporated as a single element or step in a multi-function or multi-step process. Consequently, in the discussion of the Controller 900 and 910 component functions contained herein, it should be understood that where a particular controller, PC, PLC, PID or other device with specific functions is discussed, another type of controller, PC, PLC, PID or other functionally equivalent device could be substituted for the one described. Additionally, discrete functions performed by the described Controller 900 or 910 component may be performed by another device along with other unrelated functions.

As the detailed description of Controllers 900 and 910 has revealed, the system can be operated in one or a combination of multiple related and predefined control modes; as directed by an external device or computer PC 903, or as directed by algorithms executed by the Controllers 900 and 910 using predefined controller and application logic 901, 902, 906, 907, or manually using panel mounted controls (not shown) and indicators. In each of these predefined modes, the operational parameter values and setpoints, or the algorithms used to calculate them, as well as the useful subsystem process variable identities, are known and are input as controller and application logic 901, 902, 906, 907 and setpoint data 197, 198, 199, 498, 499, 597, 697, 897, 397, 398, 399, 797, 798, 799, or are fixed using manual controls with indicator feedback. These input, predefined or calculated process parameter values, when used in one of the aforementioned control modes, are known and expected to achieve a particular operational result.

The design of the Controllers 900 and 910 allow at least one other operational method, where the Controllers 900 and 910 are used as analytical tools to determine the optimal operational parameter identities and the values of those process variables selected required to produce a particular functional result. In this experimental or application development operational mode, the setpoint data submitted represent test value ranges, or are algorithms used to calculate test value ranges, and include target performance specifications for the system and subsystems. In this mode, the controller and application logic 901, 902, 906, 907 provide both an operational test sequence algorithm that controls how each setpoint should be varied across the submitted setpoint data range, as well as an algorithm and criteria to evaluate each set of operational parameter values against the target application performance specifications. During test execution, controller and application logic 901, 902, 906, 907 store those operational setpoints that provide useful results, either a good fit or a poor match to the target performance.

Alternately, the operational trials could be directed using an external computer, PLC or other functionally equivalent device, PC 903 or another device (not shown). This device would submit trial setpoint data and trial controller or application logic to one of the Controllers 900 or 910 through an external control device interface (not shown). Once testing is complete, result data can be read by or uploaded to an external computer, PC 903, or another device (not shown) for storage or further analysis. Rather than storing only criteria matching operational test data, all result data could be stored, locally in the Controllers 900 or 910 or on a remote computer or storage device (not shown) for further analysis. In this way, a protocol describing the operational conditions and process variable selections most likely to produce a desired result can be developed using the system and Controllers 900 or 910 themselves as a test bed for new application trials and development.

Overview of an Example Field Deployment for Recycling and Recovering Metals Dissolved in Hydrofrack Flowback, Acid Mine Drainage or Process Waters: The system can be implemented and deployed as a portable, trailer- mounted system intended for use in the field at a mine or drilling site in conjunction with conventional pumping and slurry handling equipment for removal of metal ions and compounds in solution as precipitate. The system could be mounted on a portable platform (e.g., trailer), and transported to a field, mine, dirlling site, or other location where processing is desired. The following is a summary of the major process circuits implemented during portable field deployment and use. This example shows how component subsystems can be isolated as separate stand-alone systems where this arrangement yields advantages for process capacity and scaling.

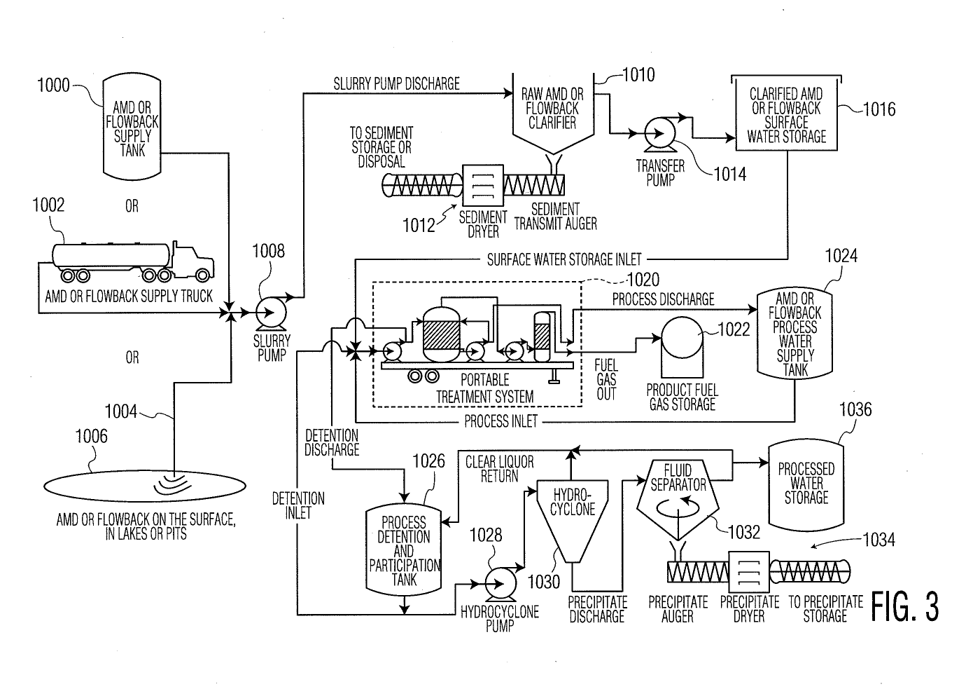

Step 1—Feedstock Pickup—Referring to FIG. 3, Acid Mine Drainage (“AMD”), flowback, or process discharge waters may be supplied from several sources. A driller or other contractor or agency may have collected drainage or wastewater and stored it in a surface vessel 1000. In this case, a portable pump, either light or medium slurry centrifugal pump 1008 with a quick connect or cam lock hose or piping system can be used to connect to and transfer tank content. A similar arrangement is suitable for tank truck 1002 off-loading. This permits treatment of process waters from multiple locations near the deployment site.

Pitted AMD or flowback requires the same equipment as tank or truck off-loading, but may additionally require installation of a rigid, semi-permanent piping system 1004 hung or mounted into a pit, lake or well 1006 at the depth required to properly operate the slurry pump. Depths below 30′ could require additional submersible booster pumps to transfer the content to the surface.

Step 2—Raw AMD or Hydrofrack Flowback Clarification—In addition to AMD or flowback water, surface, pit or lake water sources or supplies from the bottom of tanks or trucks could contain significant amounts of insoluble elements and compounds, such as silica, and other solids in suspension. These substances may comprise in excess of 40% of the mass of the raw water supply. To minimize water treatment costs, all insoluble or readily settleable solids are removed prior to water processing.

AMD or flowback passes through one or more clarifiers 1010 where solids in suspension are permitted to settle and are removed from the water. Cleared water is transferred using a conventional portable or trailer mounted trash style centrifugal pump 1014 out of the clarifier 1010 to clarified surface water storage unit. Sediment slurry from the bottom of the clarifier is periodically drained and transported by a screw auger through a kiln or rotary drier 1012 (if drying is required) to a receiving storage drop site, pit, tank or truck. Feedstock containing plastics or other low density insoluble contaminants may require additional equipment for scum management. Optionally, if the clarifier solids have value as an ore feedstock, a slurry pump or screw auger can transfer clarifier bottom slurry to the appropriate receiving vessel or hydrometallurgical process.

Standard wastewater treatment clarifiers are suitable, the number and size of units deployed at a particular site will vary based on the expected or required inflow rate, percent solids suspension and solution, flocculation and sedimentation rates and desired final TSS/TDS for optimal process performance and energy consumption, or as specified by the site operator.

Step 3—Process Feedstock Storage—AMD or flowback initially stripped of settleable solids is isolated and stored for use as input feedstock for the system, indicated at 1020. The clarified AMD or flowback can be stored in covered or uncovered surface tanks, lined pits, lakes, or wells. The capacity and number of storage units will vary and is determined by local permits, permissible surface detention time, total inflow volume, inflow rate and process rate. It is noted that one or more of the components discussed above in connection with FIGS. 1A-2B, such as the bubble collapse reactor 601, various system pumps and valves, etc., could be mounted to the portable platform shown in FIG. 3, for easy transportation to, and operation at, a desired location.

Step 4—Processing—Clarified AMD or flowback is pumped from the clarified surface storage units, reacted and transferred to the process storage vessel 1024. The processing changes the ORP, pH, DO, and TSS/TDS ratio of the water. Once the target conditions for a desired precipitate's formation are reached, the process tank content can be transferred to the detention tank 1026.

During processing, reactor headspace and dissolved gases, including alkane fuel gases, are removed from the process circuit. Fuel gases are isolated, e.g.through ceramic filtration, and stored, e.g. in an on-site gas storage sphere 1022.

The size and number of process and detention tanks and fuel gas or other product gas spheres is determined by the inflow volume, inflow rate, process rate and effective detention time as required to form a desired product precipitate.

Step 5—Precipitate Harvest—After a variable detention interval, e.g. between two and twenty-four hours, a significant amount of precipitate consisting of oxides and hydroxides of metals in solution will form. The specific precipitate compositions and rates of formation will vary, but the detention interval end condition is always measureable by TSS; 100-200 NTU indicates a sufficiently dense particle load to justify separation. Alternately, particle size distribution analysis or pH can be used to indicate detention interval termination.

The precipitate-laden process solution is pumped by a conventional, portable, high-head centrifugal pump, the hydrocyclone pump 1028, under controlled conditions through a hydrocyclone 1030 where particles within a certain mass and/or size range are removed. The selected precipitate particles are dewatered in a centrifugal or fluid separator 1032. The accumulated precipitate sediment is periodically scoured and transported by a screw auger through a kiln or rotary drier 1034 (if drying is required) to a receiving storage drop site, pit, tank or truck. Precipitate formation and separation in this manner permits recovery and recycling of metals from solutions as oxides or hydroxides, such as Fe(OH)₃.

Once the desired particles have been removed, the operating conditions of the hydrocyclone can be modulated to isolate another particle group of a different mass or size. This permits precipitate fractionation, enabling mineral and metal precipitate sorting.

Alternately, the precipitate stripped process solution can be returned to the detention tank to sit for an additional interval, or returned for additional processing. This permits staged production and recycling, allowing process operation and detention variations and optimizations as required for pH modulation and the production of specific precipitates or gas products, maximizing recyclable material production.

Step 6—Process AMD or Hydrofrack Flowback Storage—Process water stripped of selected metals and carbonaceous compounds in suspension and solution and neutralized is transferred from the detention tank 1026 or the process water tank 1036 by the hydrocyclone pump 1028 to processed water storage tank 1036.

Processed water may be suitable and permitted for surface discharge or immediate reuse or recycling on site. Alternately, processed water may be discharged from the hydrocyclone pump 1028 directly into tank trucks or another on site process inlet piping connection. In these cases, onsite storage of processed water may be partially or totally omitted.

Where storage is required by permit or for post process testing, or where a subsequent treatment process requires on site storage, uncovered or covered tanks, lined pits, wells or lakes may be used for processed water retention. The types and number of processed water storage units will vary based on site permits, available surface features or structures, the rate of processed water production, the rate of processed water recycling or reuse, and the total expected volume of processed water.

Multiple means are provided to measure, control, and optimize energy usage and functional capacities. Methods are provided to convert dissolved metal and carbonaceous compounds into stable precipitates and alkane fuel gases using a combination of bubble collapse reaction catalysis processing with varying energy input in conjunction with process solution detention intervals, requiring zero energy input. The processed aqueous solution's state changes, as a consequence of water splitting, hydrolysis and other reactions catalyzed during bubble collapse processing, permit precipitate and gas product formation to continue in detention with zero energy input. By modulating bubble collapse energy input and detention times, it is possible to generate the same precipitate or gas products using either more bubble collapse process energy and less detention time, or less bubble collapse process energy and more detention time. In this way, the process can be optimized to use energy input in place of detention time, where processing time is of the essence, or detention time in place of energy input, to reduce processing costs, while maintaining the quantity and composition of precipitate and gas products.

Staged processing of aqueous solutions is permitted, allowing formation and separation of precipitates in sequence, enabling compositional sorting and separation by precipitate formation order as well as mass and particle size, and recovery of economically useful precipitate composition mixtures without the addition of reagents or other compositions to the aqueous solution. Processing can be controlled to cause individual or groups of related compositions to precipitate in an aqueous solution in a controlled way, and a mechanism to remove these unique product precipitates, without direct or chemical pH manipulation or the addition of chemicals or flocculants.

A bubble collapse reactor is provided with design features, component selections and deployment strategies intended to serve as a blueprint for apparatus construction across the full spectrum of possible implementation scales, including bench scale, pilot scale or pilot plant scale as well as full production scale with processing capacities of millions of gallons of water per day (MGPD). The reactor may be componentized and isolated into stand-alone subsystems to provide independent, linear or near linear scalability of that set of components included in a particular subsystem. In addition, the apparatus subsystems can be controlled and integrated into a complete apparatus for efficient, controlled bubble collapse catalyzed reactions by a separate and independent integration and control subsystem.

In this way, individual subsystem apparatus selections can be substituted with other functionally equivalent apparatus of larger capacity or that provide additional features and functions. Consequently, overall capacity scale up or feature or function upgrade is performed in a modular, readily testable fashion that permits both planned and on the fly subsystem or component swap-out and trials. The individual subsystem designs, component selections and layouts are intended to enable implementation of the design across the full spectrum of possible feedstock waters with dissolved solids requiring removal, including wastewater, process water, pitted or otherwise stored mining influenced water, acid mine drainage, hydrofrack flowback, high TDS ground water, sea water or any other aqueous solution containing dissolved or suspended solids. The apparatus control and system integration subsystem design is open to permit the addition of sensors or other condition detection and control subsystems or components, not currently included as part of the apparatus design that might be required to process a specific process water feedstock at a particular rate or at a particular scale or with a subset of auxiliary feature or functions provided. In this way changes to the system as required to adapt or implement its apparatus for a particular scale or characteristics of feedstock water, or to adapt, or add particular functional capacities to as required is intrinsically enabled and simplified by virtue of the componentized and open ended subsystem integration design.

A control system is provided that can act as an analytical tool, determining the optimal operational parameter values required to achieve a target precipitate or gas product composition and production rate and, where desired, to catalyze TDS reduction or precipitate or gas production using the least amount of energy/gallon. The controller allows automatic sequential execution of operational trials using electronically stored apparatus setpoints such as system flow rate, pressure, power or other setpoint values or value ranges that may produce desirable performance characteristics, as required by a particular application. The controller automatically recalculates and varies the actual operational setpoints using the originally input setpoint values or value ranges and value modification algorithms residing in the controller. It concurrently records and subsequently analyses the trial operational results, reporting those setpoint combinations yielding desirable or best fit operational characteristics using controller residing result evaluation algorithms.

A bubble collapse catalyzed reactor test bed is provided where the primary controlling process variable identity and value can change dynamically, on demand or as required during operation. In this way, operational parameters external and internal to the bubble collapse reactor that have the most significant or desirable impact on the efficacy, precipitate formation rate, precipitate particle size distribution, composition formation rates, power consumption or other measured variable are identified, controlled and optimized during and as a consequence of system operation

The system comprises a pump system and its controller used together with auxiliary apparatus to create a chemical reactor suited for several aqueous solution precipitate and gas synthesis reactions catalyzed by controlled aqueous solution bubble formation and collapse, including water splitting.

The processing implemented utilizes controlled bubble collapse aqueous solution hydrolysis to catalyze the formation of specific compositions of iron which have commercial value as colorants, pigments and smelting process feedstock. This is accomplished without the addition of chemicals or pH adjustment.

Process trials using the methods and systems disclosed herein for mining influenced water feedstock treatment produce Fe(OH)₃ from Fe⁺³ iron in solution, at least two hydroxide compounds, Fe(OH)₃ (iron(III) hydroxide or yellow boy) and Fe(OH)₂ (green rust), and at least two oxide compounds, FeO (iron(II) oxide or ferrous oxide) and Fe₂O₃ (iron(III) oxide or yellow, red or brown ochre). The compounds are formed at various energy input levels as either likely relatively pure compositions or in some degree of mixture at different points in production and are likely often partially hydrated.

By controlling energy input during hydrolysis, metal species that may co-precipitate with iron can be isolated in useful sorted groups, as indicated by solution ORP. In this way, where arsenic, cadmium, chromium, copper, lead, nickel, selenium, vanadium, or zinc are present in solution, they can be co-precipitated with iron in a controlled way without chemical addition or pH adjustment.

The methods and systems disclosed herein provide a method to measure the in process internal charge of a solution, and a technique to correlate this measure with metal precipitate composition formation. This process measurement and control permits the process to selectively emit principally iron containing pigment compositions, or to emit principally iron coprecipitated with other metals. As a result, most of the iron can be recovered as a valuable product, and some of the iron can be used to sweep floc other metal contaminants. This maximized recycled product value and minimizes hazardous or waste disposal volume and cost.

The methods and systems disclosed herein also provide a means to use carbonation, the dissolution of carbon dioxide in an aqueous solution, as a mechanism to control and improve the rate of iron oxyhydroxide precipitate formation. Carbon dioxide reacts with protons released from water molecules during hydrolysis forming alkane gasses, which are stripped from solution during processing. Consequently, additional hydroxide is available in solution as a reagent or intermediate for production of iron oxyhydroxides from iron in solution. This increases the rate of precipitate formation and restricts the precipitate formation to pigment compositions and inhibits the formation of poly-metal containing iron co-precipitants.

### EXAMPLE

The following example describes various trials/tests conducted using the system. Two candidate feedstock iron containing acidic coal and clay mine drainage waters were evaluated using the devised Acid Mine Drainage Treatment Protocol (“AMDTP”) implemented with the system pilot scale prototype. The objectives of these AMDTP trials were:
Measure rate of conversion of iron in solution to recoverable pigments
Measure process parameter value correlations with production rate
Identify processing alternatives that will accelerate pigment formation, enabling faster throughput with no additional energy
Measure increases in process productivity through advanced control of process solution parameter values during and after processing

Rates of iron pigment formation, changes in pH and ORP, decrease in TDS and gas production changes measured indicate several effective techniques for process energy reduction and increased system throughput and capacity.

The results of these process trials demonstrate that the system is an effective tool for recovery of iron and reduction of total dissolved solids in metal, coal and clay mining influenced net acid drainage waters, specifically:
Ferrous and ferric oxyhydroxide pigment compositions are produced cost effectively using <200 mg/liter iron Acid Mine Drainage (“AMD”) feedstock
Control of dissolved gasses increases pigment formation rates
Advanced process control of pH/ORP permits product composition control
Pigment formation reduces process water TDS and neutralizes acidity

Both of the test feedstock AMD's showed in process formation of stable ferrous and ferric oxyhydroxide (abbreviated here Fe(OxHx)x) compositions from Fe⁺² and Fe⁺³ iron ions in solution. Both samples showed significant reduction in total dissolved solids, as measured through conductivity, acid neutralization and reduction in ORP, all effects as a direct consequence of process action.

The Samples in This Round of AMDTP Trials:

Two net acidic coal and clay mine drainage water samples were obtained from a PA watershed.

“Site 1” sample was obtained from the inflow to an existing passive treatment installation. Inflow water composition into this site is routinely measured containing 150 mg/liter iron, 50-140 mg/liter aluminum, 150-200 mg/liter manganese, pH 3.3-3.8, and acidity of 800 mg/liter as CaCO₃.

“Site 2” sample was obtained from an upper vent outflow of an abandoned clay mine. The composition of this effluent is routinely monitored and contains 180 mg/liter iron, 13-25 mg/liter aluminum, pH 3.1, and an acidity of 400 to 700 mg/liter as CaCO₃.

Neither sample meets the minimum iron content requirement assumptions of >250 mg/liter iron for economic pigment production. The samples composition and acidity, however, rendered them suitable for use during the development of the implemented process configurations and evaluation methods.

The Trial Results:

Samples from Site 1 and 2, fifteen gallons from each site, were split after initial characterization and assessment into two seven gallon site samples to permit side by side alternate process configuration trials and comparisons.

Site 1-A and Site 2-A samples were initially run using conditions optimized to catalyze reduction reactions and suppress oxidation reactions. This approach was determined ineffective, so both “A” samples' operating conditions were modified to catalyze redox reactions by changing operating parameter values, aeration, and the addition of up to 200 mg/liter CO₂ through carbonation. Site 1-B and Site 2-B samples were run using increasingly aggressive aeration and oxidation catalysis process configurations.

The application of the AMDTP evaluation methods reveal and differentiate suitable feedstock and effective methods. In addition, the evaluation reporting identifies conditions where alternate process methods not attempted—such as pre-process reverse osmosis water stripping or in process pigment stripping—would likely improve results.

The process economics evaluation shows that the Site 2 sample, run using the “A” process configuration, despite an iron concentration of 180 mg/liter, 70 mg/liter below the assumed lower level cutoff, may yield pigment products economically. The analysis indicates at least two energy input bands where pigment production energy costs, while high, are within the range of acceptable performance based on benchmark criteria established for AMD with iron concentrations <250 mg/liter.

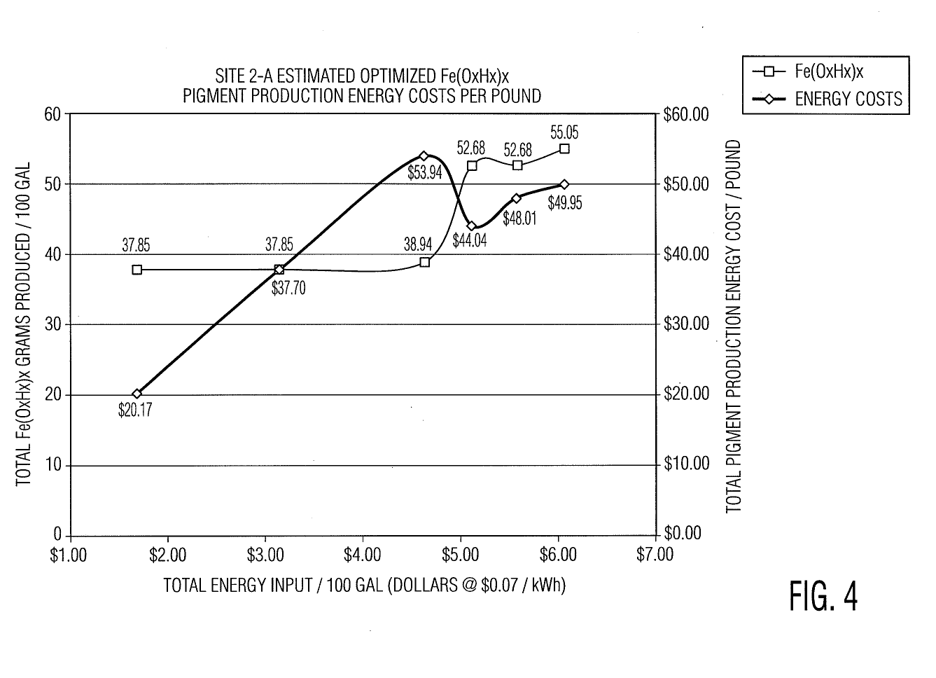

Pigment is produced with an energy cost of $20.17 energy per pound by the System in the “A” configuration with Site 2 AMD as feedstock, as illustrated in the graph set forth in FIG. 4.

The Site 2-A configuration process trial analysis indicates pigment production occurs at two ranges of energy input. Significant pigment precipitate, 37.85 grams per 100 gallons AMD processed, is produced with $1.68 energy input per 100 gallons AMD. Starting with $5.11 energy input per 100 gallons, additional pigment is produced, up to a total of 55.05 grams per 100 gallons processed with $6.06 energy input. A significant production dead band was observed between $2 and $5 energy input per 100 gallons AMD processed.

Based on this analysis, if the pigment produced has a value significantly in excess of $49.95 per pound, process trials with this material indicate $6.06 energy input per 100 gallons would yield the maximum product output amount.

If the pigment produced has a value less than $49.95 per pound but significantly more than $20.17, processing energy input should be limited to $1.68 energy input per 100 gallons. This will result in a production of 37.85 grams of pigment per 100 gallons of AMD processed, rather than the maximum product output amount of 55.05 grams of pigment per 100 gallons of AMD processed, but the energy costs will be limited to the level required for economic production.

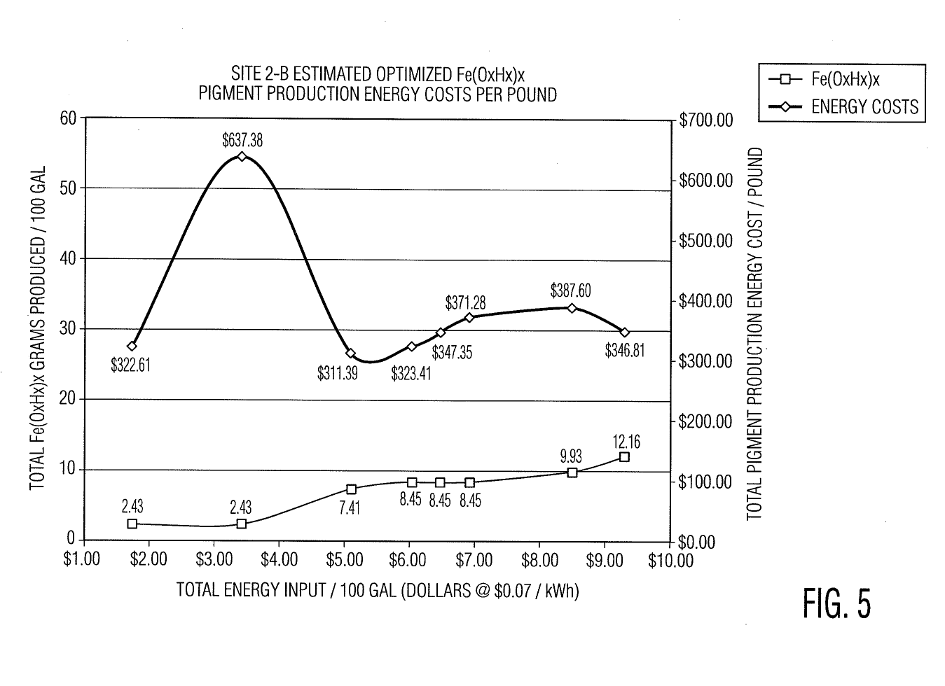

Pigment is not produced cost effectively by the System in the “B” configuration with Site 2 AMD as feedstock, as illustrated in the graph set forth in FIG. 5.

Based on this analysis, only extreme aeration, or perhaps ozonation in conjunction with system use, would present an opportunity to use oxidation catalysis alone to produce pigments at or near economical rates. The low levels of precipitate formation, however, indicate oxidation alone is largely ineffective.

Site 1 processing presents a more complex picture than that presented by the process trials of Site 2. Both the “A” and “B” process methods yield pigments and precipitates, but the composition of the products produced by the “A” method are different from the “B” method.

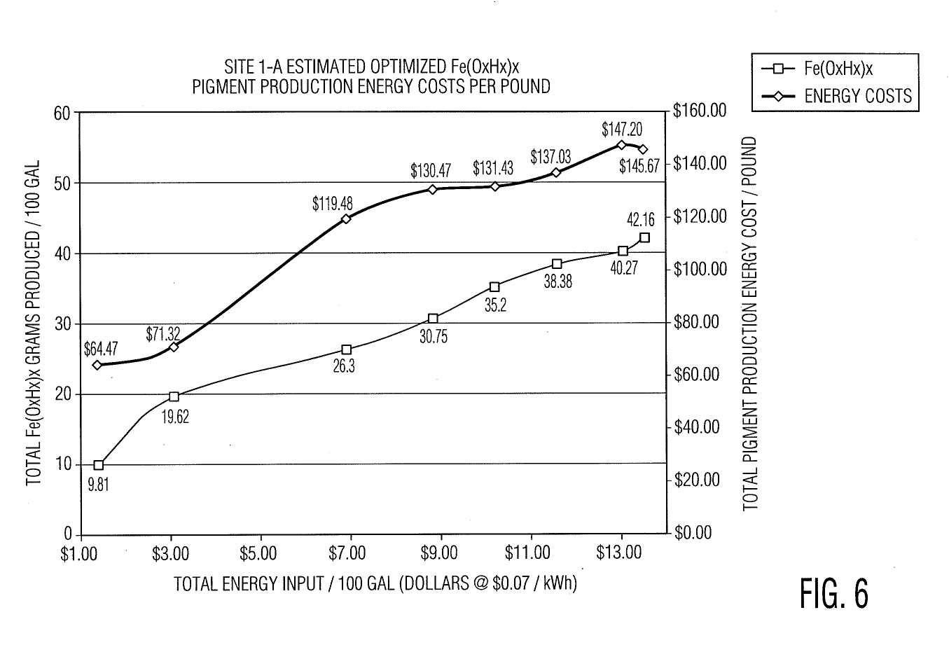

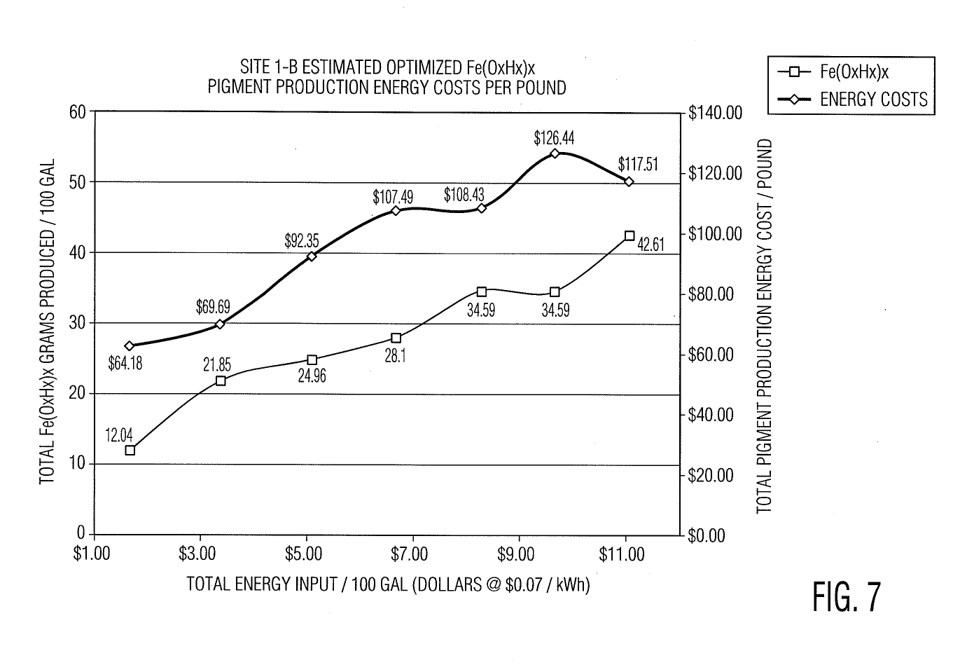

The process economics evaluation illustrated in the graphs set forth in FIGS. 6-7 shows that the Site 1 sample, run using both the “A” and “B” process configurations, despite an iron concentration of 150 mg/liter, 100 mg/liter below the assumed lower level cutoff, may yield pigment products economically. The analysis indicates that both methods continuously output additional pigment products with increasing energy. Energy usage at the low end of the productive energy input range, while high, is within the range of acceptable performance based on benchmark criteria established for AMD with iron concentrations <250 mg/liter.

Site 1-A and 1-B configuration process trial analysis indicates pigment production occurs at almost all energy input ranges, however the 1-B configuration shows a small dead band about the $9.00 energy input per 100 gallons processed point. Both samples produce approximately 20 grams of precipitate at about $70 per pound of pigment energy production cost. Energy cost in the 1-A configuration is significantly higher then the 1-B configuration at approximately 42 grams per 100 gallons of AMD processed production level. 1-A production costs per pound of pigment at this level are $145.67 versus 1-B production cost of $117.51.

Based on this analysis, if the pigment produced has a value significantly in excess of $117.51 per pound, process trials with this material indicate $11.04 energy input per 100 gallons using processing method 1-B would yield the maximum product output amount. Processing method 1-A is likely not economical at this target production rate.

If the pigment produced has a value less than $117.95 per pound but significantly more than $69.69, processing energy input should be limited to $3.36 energy input per 100 gallons. This will result in a production of at least 21 grams of pigment per 100 gallons of AMD processed using either processing method 1-A or 1-B, rather than the maximum product output amount of 42.61 grams of pigment per 100 gallons of AMD processed using method 1-B, but the energy costs will be limited to the level required for economic production.

Process Ferrous and Ferric Oxyhydroxide Pigment Product Identities:

Previous process trials using mining influenced water feedstock suggested the System's capacity to produce Fe(OH)₃ from Fe⁺³ iron in solution. Further investigation into the identities of the likely products has indicated at least two hydroxide compounds, Fe(OH)₃ (iron(III) hydroxide or yellow boy) and Fe(OH)₂ (green rust), and at least two oxide compounds, FeO (iron(II) oxide or ferrous oxide) and Fe₂O₃ (iron(III) oxide or yellow, red or brown ochre). The compounds are formed at various energy input levels as either likely relatively pure compositions or in some degree of mixture at different points in production and are likely often partially hydrated.

Fe₂O₃ and its hydrates are likely the most valuable products and colorimetric and hydrolyzation investigations suggest the process may produce both Fe₂O₃ and Fe(OH)₃ at purities in excess of 85%. Methods to determine the exact composition of the products require 100 to 200 grams per assay trial, will require some development and repetition to achieve accuracy and precision, and will require identification and preparation of sample standards and blanks.

AMD process water sample sizes in these trials varied between 6 and 8 gallons, consequently, insufficient precipitate product was produced to permit the application of XRD (X-ray diffraction) analysis for pigment composition, the preferred method, due to insufficient product sample mass.

Alternate pigment composition assay methods using TEM (transmission electron microscopy) or SEM (scanning electron microscopy) in conjunction with ICP-AES (inductively coupled plasma atomic emission spectroscopy) are possible.

Despite the lack of quantitative compositional assessment, some degree of product identification and differentiation is possible through visible inspection based on compositional suggestions derived from metal complex colorimetric categorizations. Final determination of product values, optimal production configurations and optimal input energy in process will be guided in a large part by the findings of the aforementioned compositional analysis.

Precipitate and Gas Production Correlations to pH and TDS Changes:

Gas separation and quantification apparatus designed as part of the portable field deployment implementation of the system were constructed and tested during acidic and alkaline process water trials, resulting in gas quantification and measurement technique additions to the PWTEP method devised in Phase One. These methods were also implemented during the processing of these AMD samples and integrated as applicable into the AMDTP protocol for trial processing and assessment of the samples' suitability as system feedstock.

In addition, before, during, and after process energy interval inputs, sample pH, ORP (oxidation reduction potential), TDS (total dissolved solids) and TSS (total suspended solids) are measured. This data is used to determine how changes in these values relate to process gas and precipitate product identities and production rates. In this way, process efficacy limiting conditions and conditions that align with desired production characteristics can be incorporated into further processing and testing trial setups, protocols and process control PLC recipes. These analysis identify and define configurations and operating conditions that maximize production efficiency and output and minimize production times and costs.

The first correlation that may be derived from the process trial parameter value measurements is that production and removal of iron precipitates and alkane gas products results in a reduction in total dissolved solids and neutralization of acidity. Based on these results, the samples capacity to produce additional precipitates and the energy required to achieve a particular production outcome can be deduced by the current TDS and pH of the AMD in process.

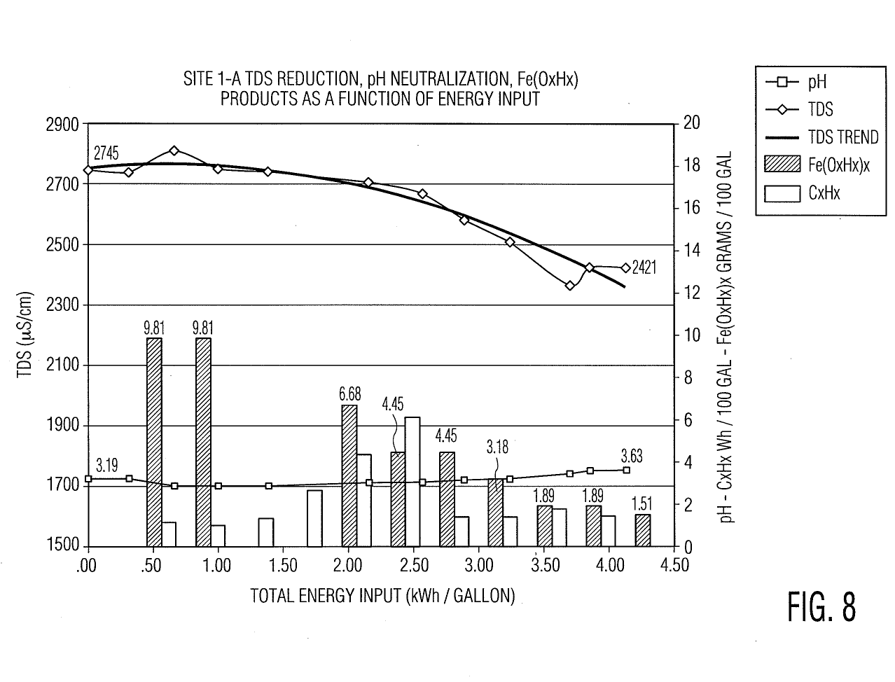

This information can be used by control feedback algorithms to regulate energy usage in process to optimize production rate, particularly when applied to implementations with designed throughput in excess of fifty gallons a minute, as illustrated in the graph set forth in FIG. 8.

In addition to correlations between precipitate production and reduction in total dissolved solids and acidity, process energy utilization, specifically, the distribution of energy input to reaction catalysis can be calculated from the analysis of changes to TDS and pH.

In Site 1-A configuration, compared to Site 1-B configuration, less iron precipitation production occurs, particularly at higher energy inputs. As a consequence, pigment production costs using Site 1-A configuration are higher than Site 1-B at higher energy costs.

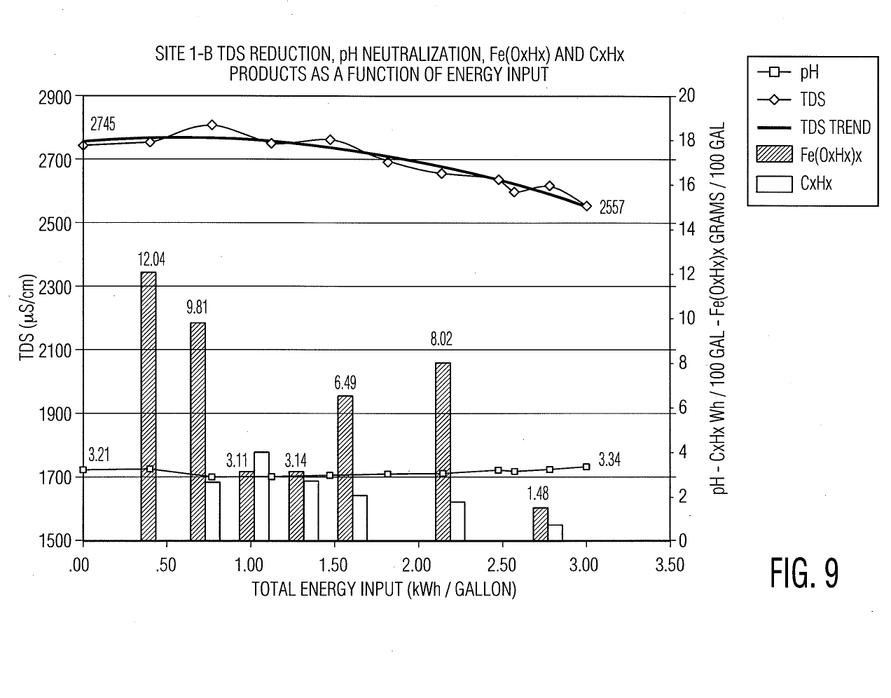

There is a benefit, however, in the use of Site 1-A configuration's approach—at higher energy input, Site 1-A configuration's energy results in an increased rate of reduction of total dissolved solids and acidity. Where the Site 1-B configuration useful work per kWh input energy diminishes significantly over 3 kWh input per gallon, the Site 1-A configuration is revealed to continue to produce small amounts of precipitate and gas, with an increasing rate of reduction in dissolved solids concentration and acidity when compared to the Site 1-B configuration, as illustrated in the graph set forth in FIG. 9.

The additional process performance information provided by the analysis of TDS, pH and production rate changes offers an opportunity for sophisticated implementation of multiple configurations at various intervals in the treatment cycle of a particular feedstock.

When a particular feedstock responds to processing as Site 1 does, where two methods may be applied for cost effective production at one energy level but vary in performance at higher energy levels, the next consideration for configuration selection is the capacity of a process configuration for the remediation of the feedstock to achieve a particular discharge standard.

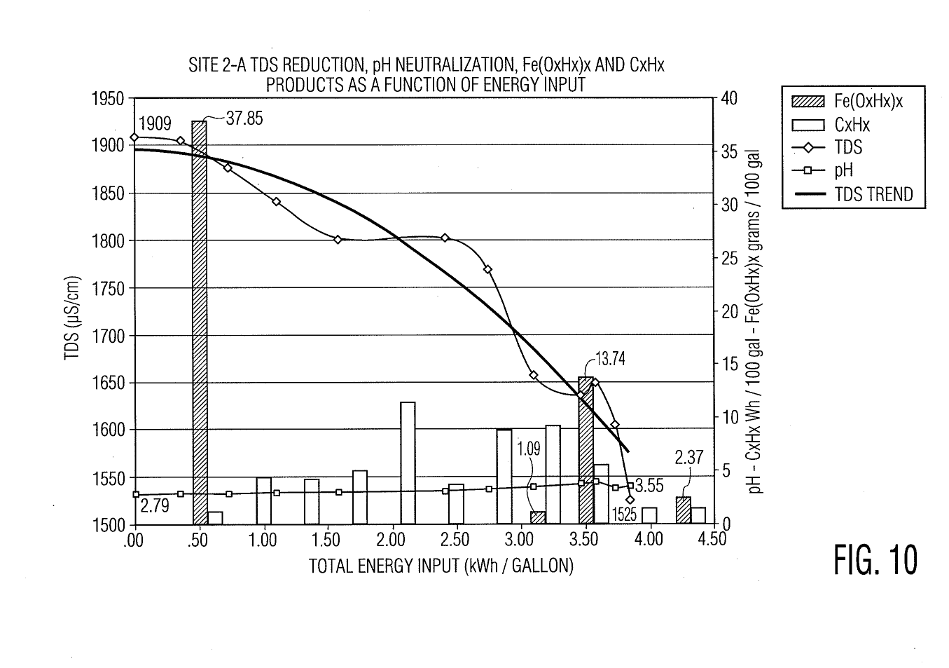

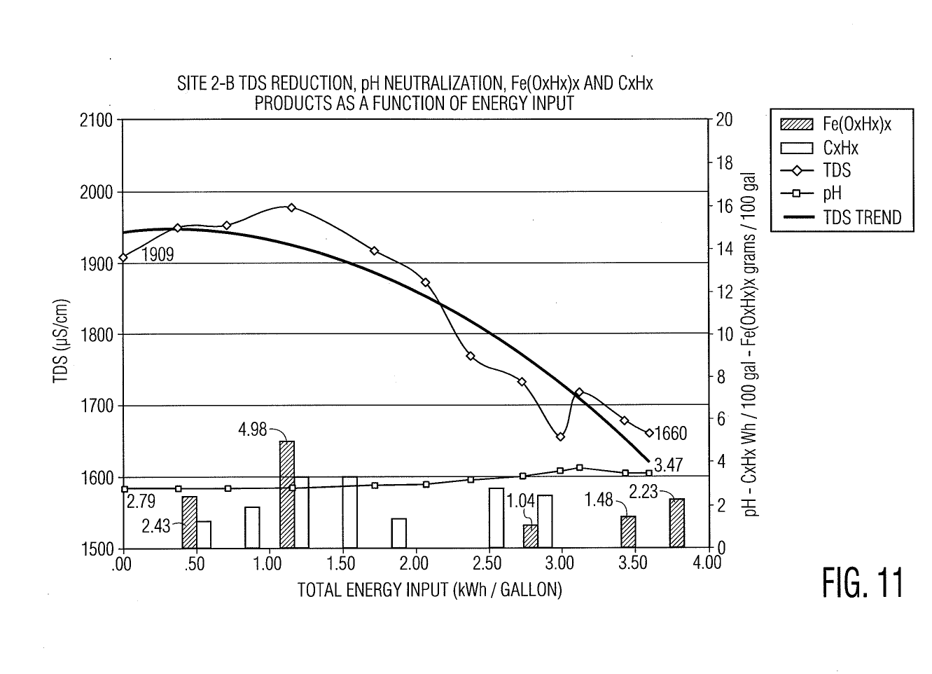

The analysis of Site 1 suggests configuration “B” should be utilized first to minimize product costs, then configuration “A” should be utilized to continue production and enhance the remedial capacity of the process for TDS and pH reduction, as illustrated in the graphs set forth in FIGS. 10-11.

The analysis of Site 2 presents a simpler picture and suggests configuration “A” should be used both for pigment production and remediation of TDS and acidity as the “A” configuration demonstrates overall superior energy utilization at all levels for each of the aforementioned purposes.

ORP, pH, and TDS Change Correlations to Precipitate and Gas Production:

The capacity of the system to produce stable ferric and ferrous and other metal oxyhydroxide precipitates without the addition of neutralizing reagents, flocculants or pH adjustment is one of the key discoveries as a consequence of the application of the AMDTP methods. The system catalyzes hydrolysis, the formation of metal oxide and hydroxide precipitates and the formation of alkane gasses. As a consequence of this action, process solution acidity and total dissolved solids are reduced.

In process, the current level of and changes in oxidation reduction potential (ORP), rather than changes in pH alone, track with production of precipitates and gas. Analysis of products as a function of ORP indicates trends in ORP—pH values that correspond with imminent precipitation or gas production or that indicate flocculation or a production dead band state.

Iron coprecipitation in conventional metal mining influenced water (MIW) treatment systems using flocculants and chemical additives has been indicated effective for arsenic, cadmium, chromium, copper, lead, nickel, selenium, vanadium, and zinc removal from affected soils and water.

The system also coprecipitates iron with these same metals and others, particularly in ferrous precipitates. ORP in this application is used to identify the current metals in solution and aids in the identification of dissolved metal valence, where the metals in solution have a known concentration.

As the precipitates are formed through the effects of hydrolysis, fine control of precipitate composition is enabled by regulating energy input, aeration or carbonation and detention intervals, using ORP values as process state or sequencing triggers. This dissolved metal recovery and sorting capacity through sequential controlled precipitation of metal oxyhydroxides was observed.

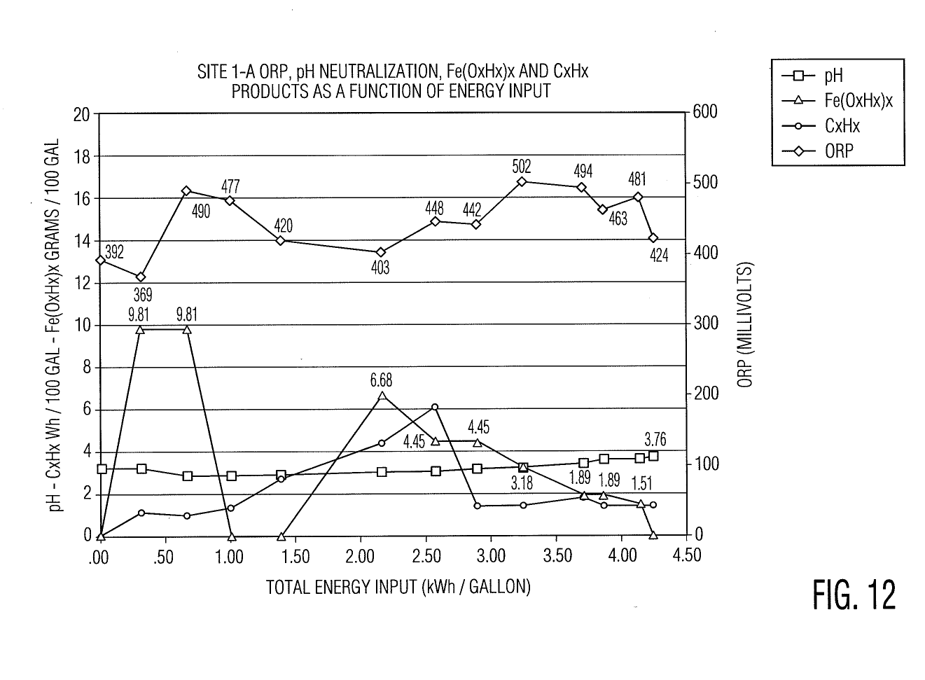

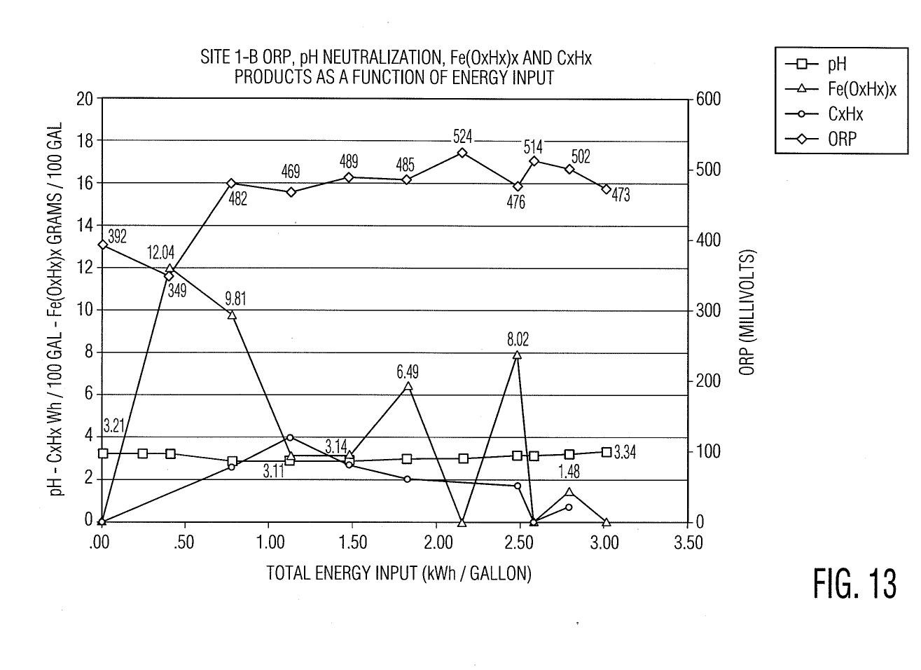

Characterization of pigment products at various points in process show that an empirical and definable relationship exists between current ORP—pH in process and likely gas and precipitate product species. A similar relationship is likely between the ORP—pH and the identities and concentrations of metals in solution or suspension, providing access to closed loop control of precipitation, as illustrated in the graphs set forth in FIGS. 12-13.

Proper utilization of this ORP trend data is dependent upon the results of the previously discussed precipitate assay methods. Where a sweep floc is produced to adsorb or coprecipitate a particular target metal, ICP-AES precipitate product trace metal composition analysis correlation with production ORP—pH could be implemented to optimize inclusion rates and efficiency for the target metal in the sweep floc produced. This process approach could be interleaved with pigment production processing so as to offset remediation costs.

The analysis of ORP—pH values measures before, during and post processing indicate trends significant in at least two ways. First, during processing of the AMD in these trials the ORP changes in characteristic ways before, during and after significant precipitate production. This effect is expected to be more pronounced as the concentration of iron and other metals in solution exceeds 500 mg/liter. Second, configuration “A” and “B” result in different ORP ranges in process. These ranges correspond to observed product identities and configuration productivity. Consequently, these values can be used in process control algorithms to optimize productivity.

Significantly, while the pH also changes periodically in a fashion that can be correlated with ORP change, there are exceptions. At several intervals of energy input in all configurations of Site 1 and Site 2 processing implemented in these trials, ORP was observed to have distinct values while pH was invariant immediately before precipitation formation or after precipitation removal from process waters. In these cases, ORP was at a specific value where the observed effect was anticipated and pH was within a particular range.

This provides an approach to form and strip precipitates without pH adjustments, and indicates that control of precipitation and the identities of the precipitates are not dependent on pH in the process as they would be using convention titration. The same approach provides an empirical means to measure and control processing efficiency during precipitate formation. In-process measurable parameter values, such as ORP—pH can be used as process variables defining operational setpoints tied to known effective values, providing a totally automated means to control process sequencing and energy usage, improving process efficiency. These techniques were implemented for process optimization in the trials as a means to control aeration and carbonation rates, to determine when a particular interval of energy input was sufficient for product synthesis, and to establish, where applicable, optimal detention intervals.

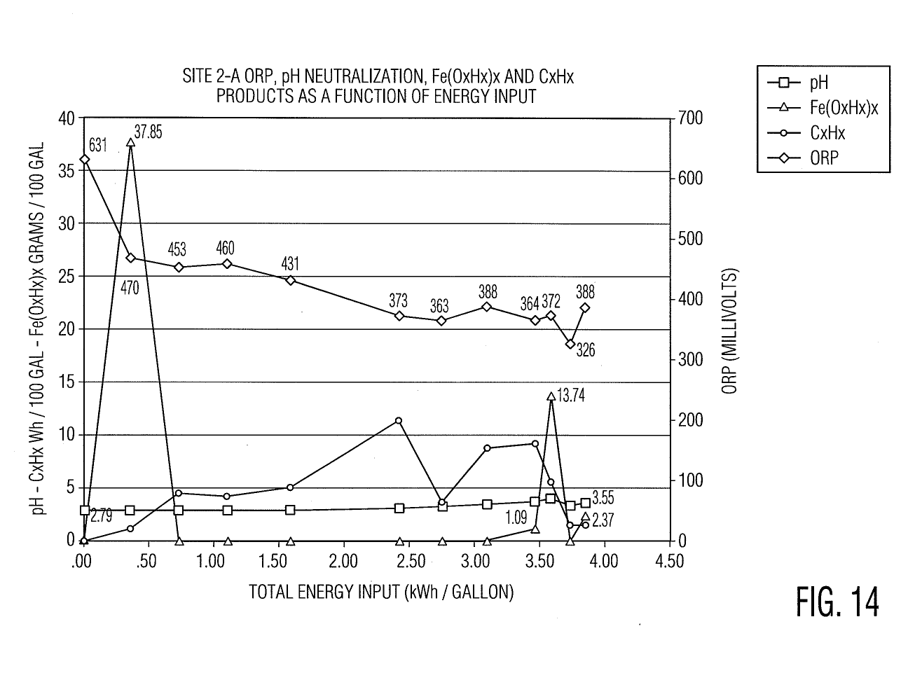

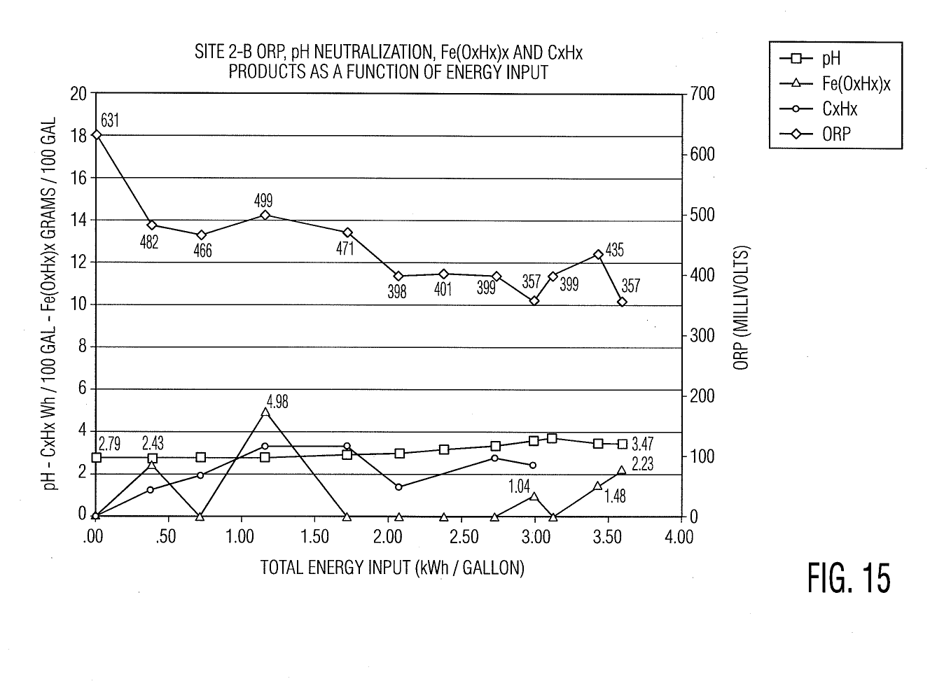

Comparative analysis of Site 1-A and Site 1-B configuration ORP—pH values and production suggest at least two useful process indicators. First, precipitate production and stripping reduce ORP from 392 to a significantly lower range of 349 to 369. In the case of Site 1, the variance in ORP value between configuration “A” and “B” after the first precipitate producing energy input range corresponds to the productivity observed in that configuration. Site 1-A trial produces 12.04 grams of precipitate with a post stripping ORP of 349 compared to Site 1-B trial that produces 9.81 and ends with an ORP of 369, as illustrated in the graphs set forth in FIGS. 14-15.

Here, the higher ORP after precipitate stripping in Site 1-B trial indicates that the configuration is not as efficient—using an ORP of 350 as an optimal value target, an ORP value of 369 indicates an incomplete removal of the desired compositions from solution. This approach can be utilized in closed loop automated control to dynamically change operating conditions to enhance production using the process variable ORP target of 350 post stripping.

The second useful process state indication from ORP value is observed at the higher energy input range where Site 1-B configuration precipitate production energy costs are lower than Site 1-A costs. Here, near economic productivity is sustained by maintaining a mean ORP in excess of 500.

The Site 1-A configuration at higher energies does not achieve this target, and is not as economical as Site 1-B. This provides a target aqueous condition—an ORP of minimum 500 mV—that will permit proper utilization of the higher energy input required to increase production rate with this material.

In this case, additional energy should not be input until the ORP of the solution has been raised to 500 or greater to permit optimal production rate at that level of energy input per 100 gallons.

Site 2-A and 2-B post initial precipitate production ORP values show a similar correlation. Site 2-A shows an initial precipitate strip ORP depression from 631 to 470 and produces 37.85 grams per 100 gallons.

By comparison, Site 2-B configuration ORP post precipitate removal ends at 482—using a depression from 631 to 470 as the optimal initial change target, 482 misses the mark, and results in the production of only 2.43 grams per 100 gallons.

Higher energy input production in Site 2 requires an ORP suppressed to a mean below 400. Maintaining an ORP below 380, as achieved during Site 2-A configuration energy input over 2 kWh per gallon, allows additional energy to produce both gas and precipitate products at a greater rate. A higher ORP appears to suppress the utility of additional energy input, as occurs in Site 2-B configuration processing at energies over 2 kWh per gallon.

This provides a method when processing this material to clamp energy usage where process solution conditions, as indicated by an ORP approaching 400, will not permit further economical production.

Having thus described the invention in detail, it is to be understood that the foregoing description is not intended to limit the spirit or scope thereof. What is desired to be protected by Letters Patent is set forth in the appended Claims.

What is claimed is:

1. An apparatus for reducing total dissolved solids in aqueous solutions, comprising:
a bubble collapse reactor having an inlet for receiving a solution and an outlet;
a pressure control valve at the inlet;
a gas and liquid separator and a fuel gas transfer pump downstream of the bubble gas reactor for removing fuel gas;
a detention and precipitation tank downstream of the gas and liquid separator; and
an outlet.

2. The apparatus of claim 1, further comprising a hydrocyclone separator downstream of the detention and precipitation tank.

3. The apparatus of claim 2, further comprising a fluid separator, a precipitate auger, and a precipitate dryer downstream of the hydrocyclone separator.

4. The apparatus of claim 1, further comprising a first controller for controlling the bubble collapse reactor, the pressure control valve, the gas and liquid separator, and the fuel gas transfer pump.

5. The apparatus of claim 2, further comprising a second controller for controlling the hydrocyclone separator.

6. The apparatus of claim 1, wherein the apparatus catalyzes reactions in an aqueuos solution between metal ions and hydroxides in solution that form stable metal oxyhydroxide precipitates.

7. The apparatus of claim 1, wherein the apparatus catalyzes formation of stable metal oxyhydroxide precipitates in an aqueous solution without chemical addition.

8. The apparatus of claim 1, wherein the apparatus catalyzes formation of stable metal oxyhydroxide precipitates in an aqueous solution without pH adjustment.

9. An apparatus for reducing total dissolved solids in aqueous solutions, comprising:
a bubble collapse reactor having an inlet for receiving a solution and an outlet;
a pressure control valve at the inlet;
a gas and liquid separator and a fuel gas transfer pump downstream of the bubble collapse reactor for removing fuel gas;
a hydrocyclone separator downstream of the gas and liquid separator; and
an outlet.

10. The apparatus of claim 9, further comprising a detention and precipitation tank between the gas and liquid separator and the hydrocyclone separator.

11. The apparatus of claim 9, further comprising a fluid separator, a precipitate auger, and a precipitate dryer downstream of the hydrocyclone separator.

12. The apparatus of claim 9, further comprising a chiller between the bubble collapse reactor and the gas and liquid separator.

13. The apparatus of claim 9, further comprising a first controller for controlling the bubble collapse reactor, the pressure control valve, the gas and liquid separator, and the fuel gas transfer pump.

14. The apparatus of claim 10, further comprising a second controller for controlling the hydrocyclone separator.

15. The apparatus of claim 9, wherein the apparatus catalyzes reactions in an aqueuos solution between metal ions and hydroxides in solution that form stable metal oxyhydroxide precipitates.

16. The apparatus of claim 9, wherein the apparatus catalyzes formation of stable metal oxyhydroxide precipitates in an aqueous solution without chemical addition.

17. The apparatus of claim 9, wherein the apparatus catalyzes formation of stable metal oxyhydroxide precipitates in an aqueous solution without pH adjustment.

18. A method of processing solution to remove dissolved solids comprising:
pumping a solution into a supply tank and allowing sediment to settle;
circulating the solution to a bubble collapse reactor at a controlled pressure;
catalyzing reactions by collapsing bubbles to convert metal ions in solution into stable metal hydroxide, oxide and other precipitates;
discharging the solution to a gas and liquid separator;
pumping off separated fuel gas;
transferring the solution to a detention and precipitation tank to remove precipitates; and
discharging the solution.

19. The method of claim 18, further comprising detaining the solution in the detention and precipitation tank until a detention termination condition is detected.

20. The method of claim 19, further comprising further processing the solution in a hydrocyclone for forming precipitate compositions.

21. The method of claim 20, further comprising separating the precipitate compositions from the solution in a fluid separator.

22. The method of claim 21, wherein the solution is transferred to the hydrocyclone if an elevation or drop in total solids in solution is detected in the detention and precipitation tank.

23. The method of claim 21, further comprising re-circulating the solution to the bubble collapse reactor after processing by the hydrocyclone.

24. The method of claim 18, further comprising re-circulating the solution to the bubble collapse reactor and the gas and liquid separator for additional processing prior to transferring the solution to the detention and precipitation tank.

25. The method of claim 24, further comprising mixing the solution with unprocessed solution before re-circulation to the bubble class reactor.

26. The method of claim 20, further comprising re-circulating the solution through the hydrocyclone and changing operating parameters of the hydrocyclone on each pass.

27. A method of harvesting Fe(OH)₃ from a process solution, comprising the steps of:
pumping a process solution into bubble collapse reactor at a controlled pressure;
catalyzing reactions by collapsing bubbles to convert metal ions in solution into stable metal hydroxide, oxide and other precipitates;
discharging the solution to a gas and liquid separator;
pumping off separated fuel gas;
transferring the solution to a hydrocyclone separator; and
harvesting Fe(OH)₃ from the solution.

28. A portable system for recovering dissolved solids from aqueous solutions, comprising:
a portable platform transportable to a location where processing of an aquesous solution is desired;
an input pump for pumping aqueous solution to be treated;
a bubble collapse reactor mounted to said portable platform and including an inlet for receiving the aqueous solution from the pump and an outlet;
a pressure control valve at the inlet of the bubble collapse reactor;
a gas and liquid separator mounted to the platform and downstream of the bubble gas reactor for separating gas from the aqueous solution;
a first outlet for discharging liquid separated by the gas and liquid separator; and
a second outlet for discharing gas separated by the gas and liquid separator.

29. The system of claim 28, further comprising a slurry pump for pumping a slurry at the location, a clarifier downstream of the slurry pump for processing the slurry, and a sediment dryer and sediment auger for processing sediment produced by the clarifier.

30. The system of claim 29, further comprising a transfer pump downstream of the clarifier for transferring clarified solution from the clarifier and a storage water tank downstream of the transfer pump for storing clarified solution, the input pump in fluid communication with the storage water tank.

31. The system of claim 28, further comprising a process water supply tank for storing liquid output by the first output for subsequent re-processing by the system.

32. The system of claim 28, further comprising a fuel gas storage tank for storing gas discharged from the second outlet.

33. The system of claim 28, further comprising a detention and precipitation tank, a hyrdocyclone, a fluid separator, and a precipitate dryer in fluid communication with the system for detaining and processing solution output by the system.

34. The system of claim 33, further comprising a processed water storage tank in communication with the fluid separator for storing processed water.

35. A method of harvesting Fe₂O₃ from a process solution, comprising the steps of:
pumping a process solution into bubble collapse reactor at a controlled pressure;
catalyzing reactions by collapsing bubbles to convert metal ions in solution into stable metal hydroxide, oxide and other precipitates;
discharging the solution to a gas and liquid separator;
pumping off separated fuel gas;
transferring the solution to a hydrocyclone separator; and
harvesting Fe₂O₃ from the solution.
